(19) United States
(12) Patent Application Publication
(10) Pub. No.: US 2026/0332171 A1
(43) Pub. Date: Oct. 22, 2026

(54) COMMUNICATION SYSTEMS AND METHODS FOR OPTIMIZING POWER USING ANALOG VOLTAGE-TO-TIME CONVERTER BASED SENSOR NODES

(71) Applicant: Quasistatics Inc., West Lafayette, IN (US)

(72) Inventors: Shreyas Sen, West Lafayette, IN (US); Gourab Barik, West Lafayette, IN (US); Baibhab Chatterjee, Newberry, FL (US)

(21) Appl. No.: 19/183,298

(22) Filed: Apr. 18, 2025

(51) Int. Cl. H04B 1/04

(52) U.S. Cl. CPC H04B 1/04; H04B 2001/0416

(57) ABSTRACT

A system and method for optimizing power using analog voltage-to-time converter-based sensor nodes is disclosed. Further, the communication system may include data acquisition unit configured to capture input data from a data source and extract analog values from the input data. Furthermore, the communication system may include transmitter communicatively coupled to the data acquisition unit. Furthermore, the linear ATC circuit may be configured to convert the analog values into a pulse width modulated (PWM) signal representing a timing information proportional to the analog values. Furthermore, the broadband communication channel may be configured to transmit the PWM signal to the receiver. Furthermore, the communication system may include receiver communicatively coupled to the transmitter via the broadband communication channel. Furthermore, the receiver may include time-to-digital converter (TDC) circuit configured to receive the PWM signal from the transmitter via the broadband communication channel and reconstruct the input data from the received PWM signal.

### TECHNICAL FIELD

Embodiments of the present disclosure generally relate to data compression systems, and more particularly relates to communication systems and methods for optimizing power using analog voltage-to-time converter-based sensor nodes.

### BACKGROUND

Communication systems are broadly categorized into two primary types: analog and digital, each with distinct characteristics that suit different application needs. Analog communication systems, while more vulnerable to noise interference, are highly valued in scenarios where low power consumption is a priority. These systems can operate effectively with lower bit resolution, making them suitable for compact, energy-efficient devices where minimizing power usage is critical. This is particularly relevant as the demand for smaller, battery-less systems grows, driven by the need to reduce bulky hardware and eliminate reliance on traditional power sources.

In contrast, digital communication systems excel in noise resilience, offering higher fidelity and accuracy in signal processing. However, this advantage comes at the cost of significantly higher power consumption, primarily due to the demands of components such as digital signal processors (DSPs) and analog-to-digital converters (ADCs). Digital systems often require resolutions exceeding eight bits, which further escalates power needs, as illustrated in typical system power consumption diagrams as illustrated in FIG. 1A. Consequently, digital implementations are less suitable for applications where low power is essential, posing challenges in designing compact, energy-efficient devices.

Further, the ADC 112B may be consistently engaged in compression process, contributing to overall power requirements of the traditional signal conversion systems. For example, FIG. 1B illustrates a block diagram of a conventional data communication system. The camera setup 102B consist of analog camera 104B, configured to generate analog image voltages from the capture image of the object or analog image voltage 106B. The data processing approach 108B includes the analog image 110B, an ADC 112B and the digital signal processing block 114B. The major contributing factor to power consumption in traditional systems lies in the continuous operation of the ADC 112B while converting the analog image voltage to the digital bits 116B within the digital domain. This energy-intensive process involves a plurality of constituting registers and division blocks, leading to substantial power requirements.

Conventional digital approaches, exemplified by some of the existing solutions exhibit substantial power requirements that are often incompatible with the restricted power budgets of the traditional communication systems involving imaging sensor nodes.

As imaging technologies continue to advance, there is an increasing demand for ultra-low-power solutions to enable prolonged operation, particularly in remote or resource-constrained environments. Although the current state-of-the-art, as illustrated in FIG. 1C, enables the conversion 126C of analog voltage signal into pulse width modulated signal 124C. Furthermore, the transmission of signal is performed using backscatter communication 128C in comparatively less energy.

FIG. 1D illustrates a conventional approach 130D of a system consisting of an analog camera 104D configured to capture the frame for proceeding to the digitization of the captured analog frame through ADC 112D. Furthermore, compression and digital signal processing 114D is performed on the digitized signal which is then forwarded to receiver 134D for enabling decompression and reconstruction of the signal. However, the technique of converting the signal from analog to digital samples is power inefficient.

Typically, the standard sensor node and receiver architecture 100E, as illustrated in FIG. 1E, comprises of an analog camera 104E along with a battery powered transmitter 138E for transmitting signal through the communication channel 140E. The battery powered receiver unit 134E receives the signal for performing reconstruction and developing the original signal 136E.

With the growing presence of body-worn cameras, head-mounted devices, and smart glasses in the era of Internet of Bodies (IoB) and Internet of Things (IoT), the demand for low-power, smaller formfactor nodes for video sensing, computing, and communication with an ability for long term usage and easy integration on the body have been steadily increasing. As shown in FIG. 1F, conventional architectures 100F employ front-end ADCs to convert all the sensed analog samples to digital bits (high data volume) and then compress it using DSP blocks before communication. However, such implementations consume high conversion energy and generate huge data volumes that need significant energy for communicating over wireless modalities, like Wi-Fi (which consumes 50-400 mW for HD video at 30 fps), Bluetooth may not yet transfer HD video), and the like. Recent non-IC based video sensing solutions uses pulse-width modulated backscatter system, where the analog sampled values are converted to pulse widths before modulation, using COTS components and backscatter communication, which cannot support higher bandwidth. Although it eliminates the need for front-end ADC, the solution has bigger form factor and can function with only smaller frame sizes (112×112 at 13 fps), while consuming significantly higher power (2.36 mW), which makes it unsuitable for high-speed video transmission around the human body.

Traditional approaches employ the analog-to-digital conversion (ADC) block in the architecture in order to transform the analog voltage signal into digital samples. FIG. 1F illustrates the graphical representation 100F which depicts the increase in conversion energy with increase in frames 100F. Therefore, analog-to-digital converters (ADCs) become energy-inefficient as the frames, i.e., the number of bits, is increased. Similarly, FIG. 1G presents a graphical representation 100G of the relationship between data volume and frame size. As the frame size increases, the corresponding data volume also increases 100G. FIG. 1H illustrates a graphical representation of energy expenditure versus the number of bits communicated or switched. As the data volume increases, the corresponding communication energy consumption also rises, which is particularly undesirable in energy-constrained environments.

Referring to FIG. 1I, the possible application scenario 1001 of ultra-low power VSN can be smart glasses, unmanned aerial vehicles, drones, body worn cameras, ingestible pills, security/spy cameras, and the like, where there is a need for these low power VSN to improve the battery life or work with energy harvested from energy harvesting mechanisms.

Moreover, the transition towards analog processing, as observed in some of the existing solutions, underscores the need for alternative methodologies that utilize analog schemes to perform communication tasks efficiently. The noise margins associated with analog processing, when compared to digital counterparts, provides an advantage in terms of power efficiency. However, existing analog solutions lack an end-to-end methodology for directly converting analog pixel data into digital format in less power.

Therefore, there is a need in the art to provide a system and method for converting direct analog samples to compressed digitized samples by shifting entire processing, including arithmetic manipulations, to the analog domain and to significantly enhance overall energy efficiency of conversion processes to address the aforementioned deficiencies in the art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a communication system for optimizing power using analog voltage-to-time converter-based sensor nodes. Further, the communication system may include a data acquisition unit configured to capture input data from a data source and extract analog values from the input data. Furthermore, the communication system may include a transmitter communicatively coupled to the data acquisition unit. Furthermore, the transmitter may include a linear analog voltage-to-time converter (ATC) circuit. Furthermore, the linear ATC circuit may be configured to convert the analog values into a pulse width modulated (PWM) signal representing a timing information proportional to the analog values. Furthermore, the communication system may include a broadband communication channel coupled between the transmitter and a receiver. Furthermore, the broadband communication channel may be configured to transmit the PWM signal to the receiver. Furthermore, the communication system may include a receiver communicatively coupled to the transmitter via the broadband communication channel. Furthermore, the receiver may include a time-to-digital converter (TDC) circuit configured to receive the PWM signal from the transmitter via the broadband communication channel and reconstruct the input data from the received PWM signal.

Another aspect of the present disclosure provides a method for optimizing power using analog voltage-to-time converter-based sensor nodes. Further, the method may include capturing, via data acquisition unit, input data from a data source and extract analog values from the input data. Furthermore, the method may include converting, via linear ATC circuit, the analog values into a pulse width modulated (PWM) signal representing a timing information proportional to the analog values. Furthermore, the method may include transmitting, via broadband communication channel the PWM signal to the receiver. Furthermore, the method may include receiving, via time-to-digital converter (TDC) circuit, the PWM signal from the transmitter via the broadband communication channel and reconstruct the input data from the received PWM signal.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1A illustrates an exemplary graphical representation depicting a comparison of power requirements by analog and digital communication, according to prior art;

FIG. 1B illustrates an exemplary block diagram of conventional camera system for wireless data transmission, according to prior art;

FIG. 1C illustrates an exemplary block diagram of a conventional low-power camera system in which the analog image signal from the camera is converted into pulse-width modulated (PWM) signals rather than digital data, according to prior art;

FIG. 1D illustrates an exemplary block diagram of a conventional communication system in which an image is captured using a camera and converted into digital data, where the digital data is then compressed and transmitted wirelessly, according to prior art;

FIG. 1E illustrates an exemplary block diagram of traditional analog camera which captures an image and transmits it to a receiver via a traditional communication channel, according to prior art;

FIG. 1F illustrates an exemplary graphical representation of traditional ADC conversion Energy versus Frame size, according to prior art;

FIG. 1G illustrates an exemplary graphical representation depicting a Data volume versus Frame size, according to prior art;

FIG. 1H illustrates an exemplary graphical representation of Energy Expenditure versus Number of bits communicated/switched, according to prior art;

FIG. 1I depicts a schematic representation of the possible application scenario of ultra-low power VSN with energy harvested from energy harvesting mechanisms, according to prior art;

FIG. 2 illustrates an exemplary network architecture for optimizing power using analog voltage-to-time converter-based sensor nodes, according to an example of the present disclosure;

FIG. 3 illustrates an exemplary detailed block diagram of the communication system for optimizing power using analog voltage-to-time converter-based sensor nodes, according to an example of the present disclosure;

FIGS. 4A-B illustrates an exemplary system architecture of asymmetric sensor node system, according to an example of the present disclosure;

FIG. 5 illustrates an exemplary diagram of small body-worn sensors to collect data and send to a more powerful hub for processing, according to an example of the present disclosure;

FIG. 6 illustrates an exemplary block diagram of the present disclosure using an analog-to-time converter to perform communication, according to an example of the present disclosure;

FIG. 7 illustrates an exemplary graphical representation of Electro-Quasistatic (EQS) communication offering over 100× stronger signal with no leakage compared to traditional methods, according to an example of the present disclosure;

FIG. 8 illustrates an exemplary block diagram of the architecture of an Analog to Time Converter (ATC) system used for image reconstruction, according to an example of the present disclosure;

FIGS. 9A-B illustrates a detailed schematic diagram of an Analog-to-Time Converter (ATC) for generating a pulse-width modulated (PWM) waveform corresponding to an analog input signal, according to an example of the present disclosure;

FIG. 10 illustrates an exemplary circuit diagram of a 7-stage current-starved ring oscillator, according to an example of the present disclosure;

FIG. 11 illustrates an exemplary circuit diagram of a static comparator comparing two input voltages, according to an example of the present disclosure;

FIG. 12 illustrates an exemplary schematic of a controlled current source that uses a reference current (Iref) and a 5-bit DAC, according to an example of the present disclosure;

FIG. 13 illustrates an exemplary diagram of HBC Driver circuit that uses a capacitor (Cp) and a control voltage (V_{ctrl}), according to an example of the present disclosure;

FIG. 14 illustrates an exemplary waveforms of varying input signal in response to the sampling clock, according to an example of the present disclosure;

FIG. 15 illustrates an exemplary graphical representation of relationship between pulse width and input voltage across various sampling rates, according to an example of the present disclosure;

FIG. 16 illustrates an exemplary graphical representation of input voltage and pulse width range vary with clock frequency, according to an example of the present disclosure;

FIG. 17 illustrates graphical representation of power consumption versus data rate for various supply voltages, according to an example of the present disclosure;

FIG. 18 illustrates an exemplary Shmoo plot of operability of ATC-VSN across supply voltages and sample rates, according to an example of the present disclosure;

FIG. 19 illustrates an exemplary graphical representation of energy efficiency versus total power consumption, according to an example of the present disclosure;

FIG. 20 illustrates an exemplary graphical representation of the PSNR versus clock Frequency, according to an example of the present disclosure;

FIG. 21 illustrates an exemplary graphical representation of the SSIM versus clock Frequency, according to an example of the present disclosure;

FIG. 22 illustrates an exemplary block diagram representation of end-to-end flow of image processing using the ATC-VSN chip, according to an example of the present disclosure;

FIG. 23 illustrates visual comparisons between original and reconstructed images for evaluating the image fidelity of the present analog-to-time converter (ATC)-based communication system, according to an example of the present disclosure;

FIG. 24 illustrates a graph depicting broadband communication channel required to lower the communication energy efficiency, according to an example of the present disclosure; and

FIG. 25 illustrates an exemplary flowchart for optimizing power using analog voltage-to-time converter-based sensor nodes, according to an example of the present disclosure.

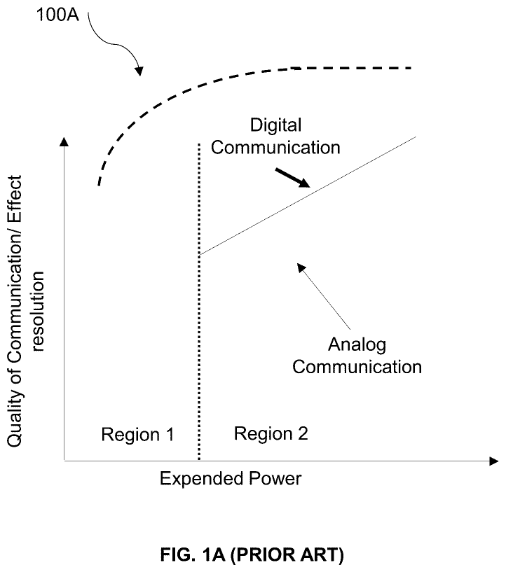

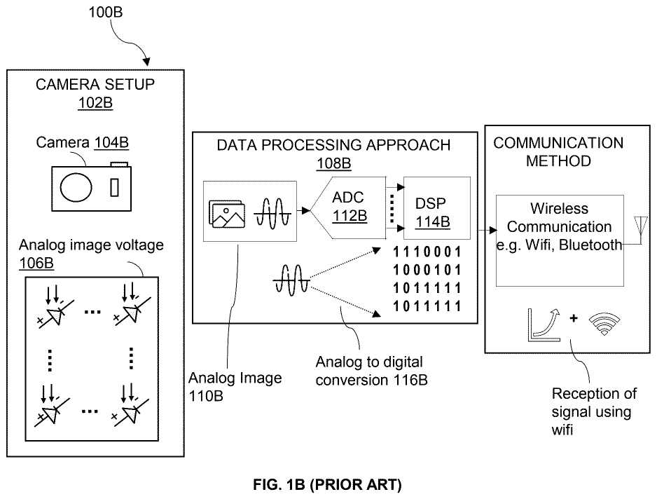

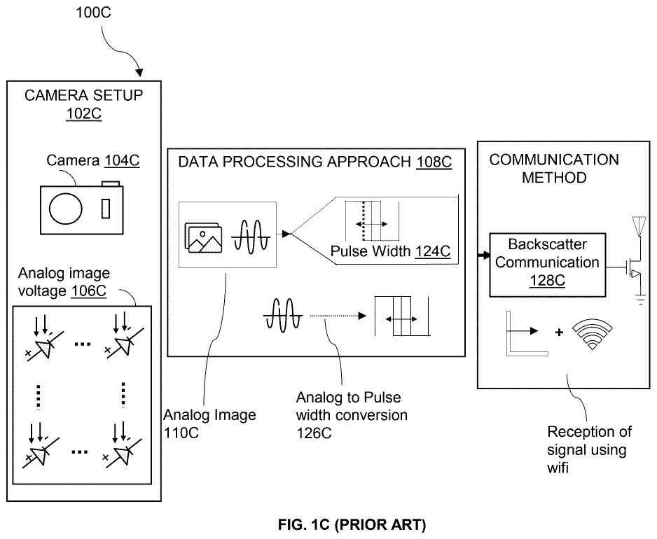

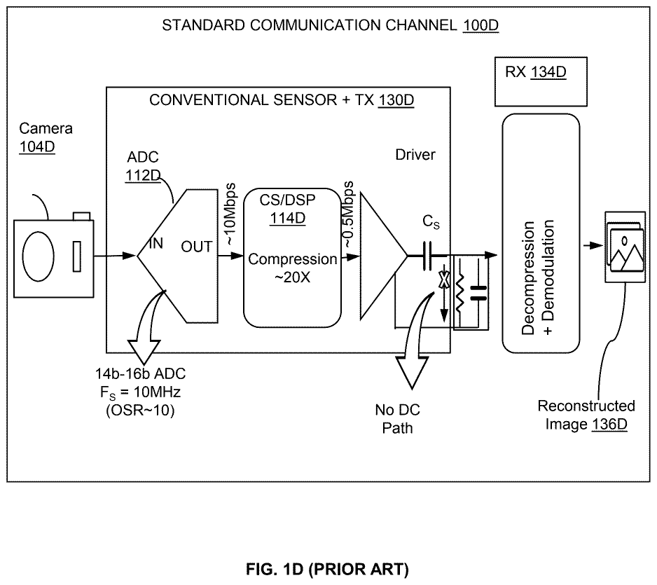

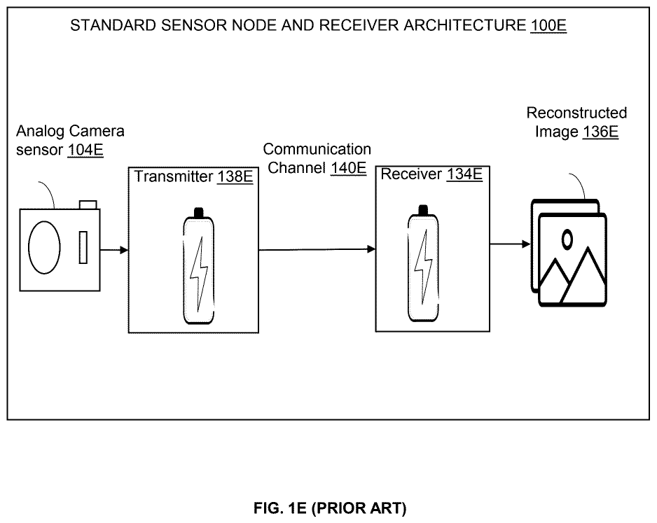

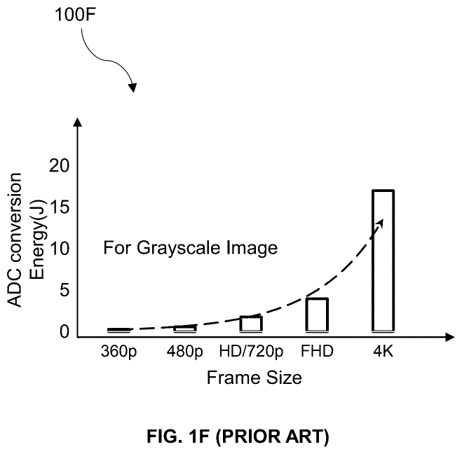

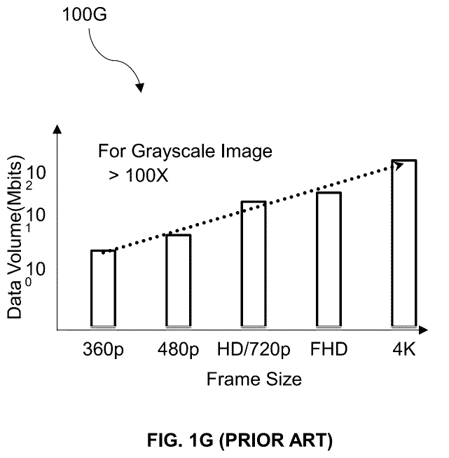

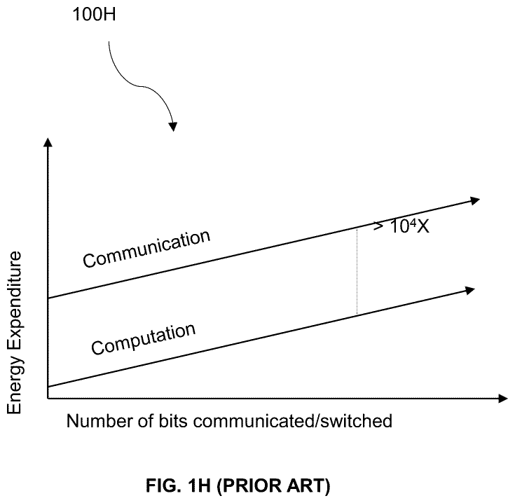

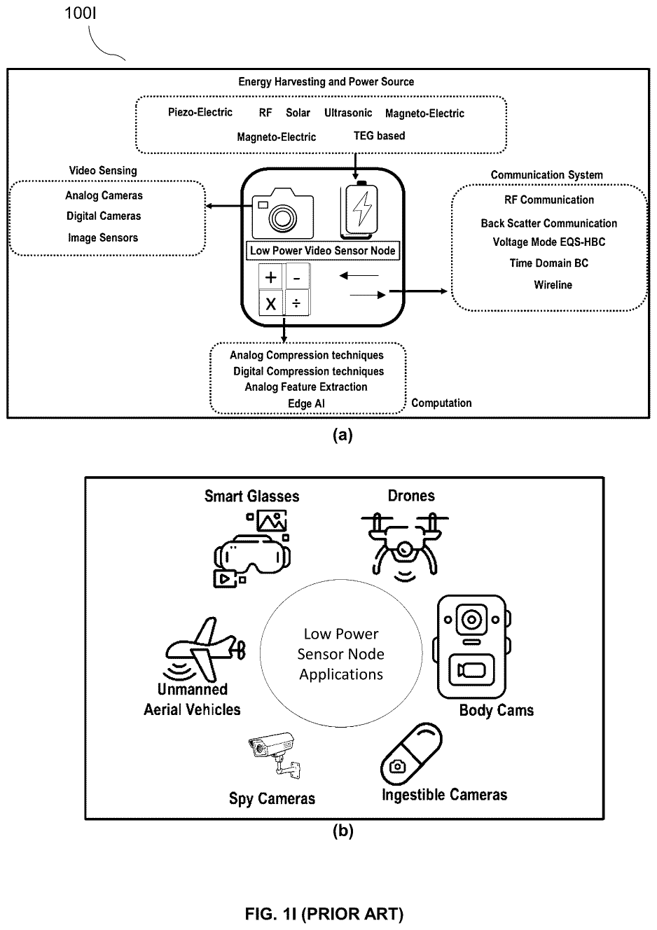

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

In recent years, Human Body Communication (HBC) has emerged as a promising low-power alternative for wireless communication, providing easy integration with the body and keeping the data secured close to the body. These sensor nodes are also required to get real time inference from the data received from the sensors for proper data analysis. This inferencing workload can be transferred to an On-Body processing hub which can be of higher power and larger form factor, hence, transferring the high-power processing from the sensors to the hub, enabling distributed processing of the signal. The present disclosure presents the first monolithic solution ATC-VSN (Analog Voltage to Time Converter Video Sensor Node) for ultra-low power energy harvester friendly VSNs, to achieve a low-power sensing and communication solution for transmitting video around the body. It exploits the time-domain data representation to eliminate the need for front-end ADC and utilizes the low power, wideband and secure HBC communication modality to transmit the pulse-width modulated analog voltage signal through the human body to the On-Body processing hub where the real time inferencing can be realized exhibiting >21.9 pJ/Sa energy efficiency, which is orders of magnitude improvement over state-of-the-art techniques. For body worn cameras, a design space is explored where a direct ATC image sensor output followed by ultralow power (ULP) HBC channel using time domain samples may enable order of magnitude reduction of power consumption in body worn VSNs, making ATC-based VSNs an energy-efficient replacement for ADC less implementations.

A video sensor consists of the image sensor pixel array, power source to perform the various functionality, communication, and computation block. The image sensor pixel array may be any analog camera, digital camera or ay image sensor. For powering the VSN, it may be battery powered or extract its energy from various energy harvesting mechanism from various sources such as solar, RF, thermal, and the like. It is expected to have some low power computing provision on the VSNs to perform compression in the analog/digital domain, extract feature from the sensed pixels or perform edge AI to do desired operations on the sensed pixels. Lastly, the bits (digital)/samples (analog) may be communicated using standard communication techniques such as RF, backscatter, Bluetooth, BLE and very high energy efficient communication techniques such as voltage mode EQS-HBC, Time domain Body communications.

Embodiments of the present disclosure provides communication systems and methods for optimizing power using analog voltage-to-time converter-based sensor nodes. Further, the communication system may include a data acquisition unit configured to capture input data from a data source and extract analog values from the input data. Furthermore, the communication system may include a transmitter communicatively coupled to the data acquisition unit. Furthermore, the transmitter may include a linear analog voltage-to-time converter (ATC) circuit. Furthermore, the linear ATC circuit may be configured to convert the analog values into a pulse width modulated (PWM) signal representing a timing information proportional to the analog values. Furthermore, the communication system may include a broadband communication channel coupled between the transmitter and a receiver. Furthermore, the broadband communication channel may be configured to transmit the PWM signal to the receiver. Furthermore, the communication system may include a receiver communicatively coupled to the transmitter via the broadband communication channel. Furthermore, the receiver may include a time-to-digital converter (TDC) circuit configured to receive the PWM signal from the transmitter via the broadband communication channel and reconstruct the input data from the received PWM signal.

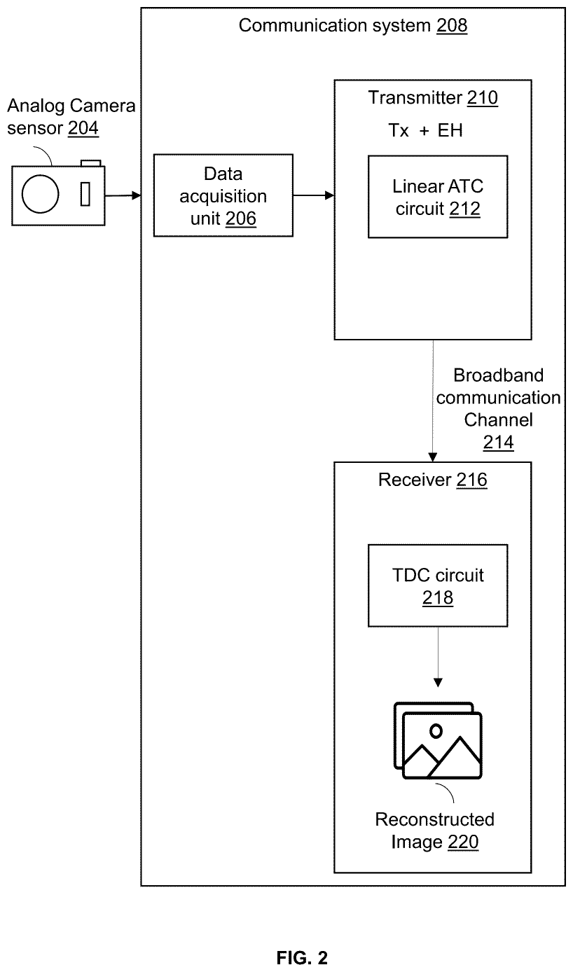

Referring now to the drawings, and more particularly to FIG. 2 through FIG. 23, where similar reference characters denote corresponding features consistently throughout the figures, there are shown preferred embodiments and these embodiments are described in the context of the following exemplary system and/or method.

FIG. 2 illustrates an exemplary network architecture 200 for optimizing power using analog voltage-to-time converter-based sensor nodes, according to an example. Further, the network architecture 100 may include an analog sensor camera 204, a data acquisition unit 206, and a communication system 208. Furthermore, the communication system 208 may include a transmitter 210 connected to the receiver 216 via a broadband communication channel 214. Furthermore, the transmitter 210 may include a linear analog voltage-to-time converter (ATC) circuit 212. Furthermore, the receiver 216 may include a time-to-digital converter (TDC) circuit 218 configured to form the reconstructed image 220.

In an example, the communication system 208 may include a data acquisition unit 206 configured to capture input data from a data source and extract analog values from the input data. Further, the data source may be referred to the analog camera sensor 204. Furthermore, the communication system 208 may include a transmitter 210 communicatively coupled to the data acquisition unit 206. Furthermore, the transmitter 210 may include a linear analog voltage-to-time converter (ATC) circuit 212. Furthermore, the linear ATC circuit 212 may be configured to convert the analog values into a pulse width modulated (PWM) signal representing a timing information proportional to the analog values. Furthermore, the communication system 208 may include a broadband communication channel 214 coupled between the transmitter 210 and a receiver 216. Furthermore, the broadband communication channel 214 may be configured to transmit the PWM signal to the receiver 216. Furthermore, the communication system 208 may include a receiver 216 communicatively coupled to the transmitter 210 via the broadband communication channel 214. Furthermore, the receiver 216 may include a time-to-digital converter (TDC) circuit 218 configured to receive the PWM signal from the transmitter 210 via the broadband communication channel 214 and reconstruct the input data from the received PWM signal.

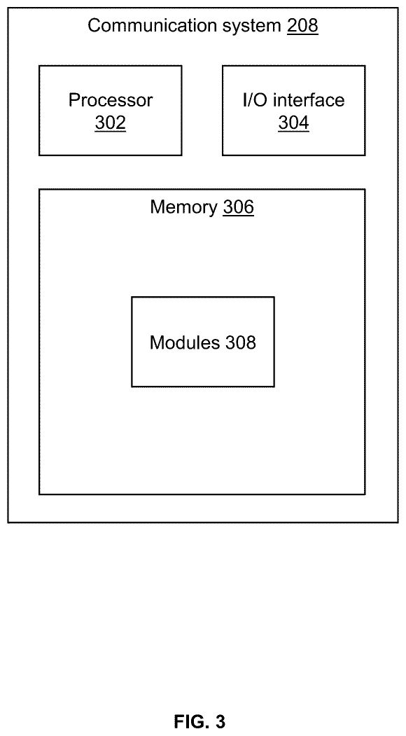

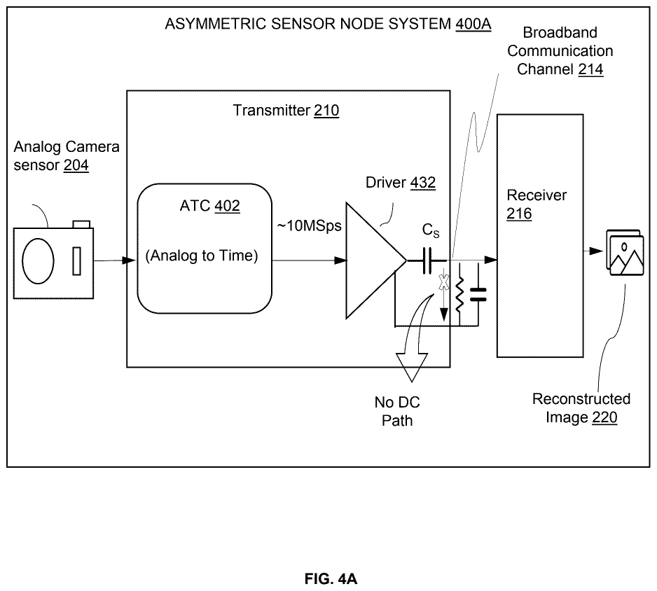

FIG. 3 illustrates an exemplary detailed block diagram of the communication system 208 for optimizing power using analog voltage-to-time converter-based sensor nodes, according to an example. Further, the communication system 208 may include a processor 302, an I/O interface 304, and a memory 306 coupled to the processor 302. Furthermore, the memory 306 may include plurality of modules 308. In an example, the processor 302 may be the processor 302 of the transmitter 210, and the processor 302 of the receiver 216. In an example, embodiment, the communication system 208 may be a transmitter or a receiver or a system comprising both, that is, transceiver.

In an example, the processor 302 is configured to capture input data from a data source and extract analog values from the input data using data acquisition unit 206. Further, the analog values may be derived from an analog input waveform, and further the PWM signal generated by the comparator may reflect variations in the analog input waveform through corresponding changes in the pulse width.

Further, the data source may be referred to the analog camera sensor 204. Furthermore, the processor 302 may be configured to convert the analog values into a pulse width modulated (PWM) signal representing a timing information proportional to the analog values using the linear ATC circuit 212. Furthermore, the linear ATC circuit 212 may include an analog compression circuit an analog compression circuit coupled between the data acquisition unit and the sample-and-hold circuit, further the processor 302 may be configured to compress the analog values by a compression factor (C) in an analog domain before conversion to the PWM signal using analog compression circuit. Furthermore, the processor 302 may be configured to generate a sampling clock for a sample-and-hold circuit based on the analog values using a multi-stage oscillator. Furthermore, the processor 302 may be configured to sample the analog values using the sampling clock and hold a sampled voltage on a capacitor using the sample-and-hold circuit communicatively coupled to the multi-stage oscillator. The capacitor may be a sampling capacitor. Furthermore, the sampling may include a positive sampling phase duration depends on charging time of the capacitor to an input voltage range. Furthermore, the processor 302 may be configured to discharge the sampled voltage on the capacitor based on the positive sampling phase duration using a controlled current source. Furthermore, the processor 302 may be configured to compare the discharging voltage with a threshold voltage and generate the pulse width modulated (PWM) signal using a comparator. Further, the PWM signal may include a pulse width being proportional to the analog values. Furthermore, the linear ATC circuit 212 may include at least one of a combination of NMOS-based device and a PMOS-based device if the analog input voltage may be from a lower voltage to a supply voltage, and further the linear ATC circuit 212 may include at least one PMOS-based device if the analog values are mapped to lower voltages.

In an example, the multi-stage oscillator may correspond to one of an n-stage ring oscillator, crystal oscillator, injected locked oscillator, and phase locked loop along with a reference clock, and further the sampling clock may include a frequency adjustable between, for example, but not limited to, 10 kHz and 25 MHz by controlling using a controlling knob. Further, the controlling knob may include, for example, a bias voltage (Vbiasn) and a supply voltage (VDD_CLK) of the multi-stage oscillator. Further, the processor 302 may be configured to adjust a discharge current based on an operating frequency of the transmitter 210 using controlled current source. Furthermore, the discharge current increases with higher input frequencies and decreases with lower input frequencies. Furthermore, the processor 302 may be configured to adjust a threshold value, and a sensitivity level of each of the controlled current source and the comparator based on the operating frequency and an input voltage range using the controlled current source. Furthermore, the processor 302 may be configured to perform a coarse tuning of the discharge current by varying a reference current to a specific current value using the controlled current source. Furthermore, the processor 302 may be configured to perform a fine tuning of the discharge current by using a n-bit digital-to-analog converter (DAC) using the controlled current source.

In an example, the comparator may include a current mirror load amplifier followed by resistive feedback amplifiers generating a gain of 60 dB, and wherein the comparator is configured to operate during a discharge phase of the sampled voltage. Further, the processor 302 may be configured to sample the analog values during a first phase of the sampling clock using sample-and-hold circuit. Furthermore, the processor 302 may be configured to discharge the sampled voltage during a second phase of the sampling clock using the controlled current source, and further the second phase being opposite to the first phase.

Furthermore, the transmitter 210 may include an electro quasistatic communication driver unit including one of a chain of buffers, adiabatic drivers and at least one inverter. Furthermore, the processor 302 may be configured to transmit the PWM signal to the receiver 216 over the broadband communication channel 214 using electro quasistatic communication driver unit. Furthermore, the processor 302 may be configured to operate in a Return-to-Zero (RZ) mode to transmit the PWM signal using the electro quasistatic communication driver unit, and further the PWM signal varies based on analog input waveform representing the analog values. Furthermore, the processor 302 may be configured to selectively generate one of a BiPhasic signal and an On-Off Keying (OOK)—like signal based on a control voltage (Vctrl) using the electro quasistatic communication driver unit. Furthermore, the BiPhasic signal may be generated when the control voltage (Vctrl) is ON, and the OOK-like signal may be generated when the control voltage (Vctrl) is OFF.

In an example, the processor 302 may be configured to transmit the PWM signal to the receiver 216 over a broadband communication channel 214. Further, the broadband communication channel 214 may include, for example, but not limited to, at least one of a voltage mode Electro-Quasistatic Human Body Communication (EQS-HBC) and a Time Domain Body Communication (TD-BC). Furthermore, the communication system 208 may include a receiver 216 communicatively coupled to the transmitter 210 via the broadband communication channel 214. Furthermore, the processor 302 may be configured to receive the PWM signal from the transmitter 210 via the broadband communication channel 214 and reconstruct the input data from the received PWM signal using the time-to-digital converter (TDC) circuit 218. Furthermore, the processor 302 may be configured to capture the PWM signal transmitted from the transmitter 210 via the broadband communication channel 214. Furthermore, the processor 302 may be configured to reconstruct the input data from the PWM signal by converting the pulse widths into corresponding values.

Furthermore, the TDC circuit 218 may include a counter operating with an oversampling high-frequency clock, further the counter may be enabled during a pulse width of the PWM signal. Furthermore, the processor 302 may be configured to count during a presence of a pulse using the counter. Furthermore, the oversampling high-frequency clock may include a frequency determined by a lowest bit resolution (LSB) in time domain. Furthermore, the processor 302 may be configured to enable the counter during the pulse width of the PWM signal, further the counter may generate a count output corresponding to a timing information of the PWM signal and further the count output corresponds to the pulse width corresponding to a minimum input voltage. Furthermore, the processor 302 may be configured to increment, during each LSB step, the counter output by the oversampling factor of the high frequency counter clock to the lowest time domain step (LSB) in the time domain, the TDC circuit corresponds to one of a delay-line-based TDC and an analog TDC.

Further, the processor 302 may be configured to compress the analog values by a compression factor (C) in an analog domain before conversion to the PWM signal.

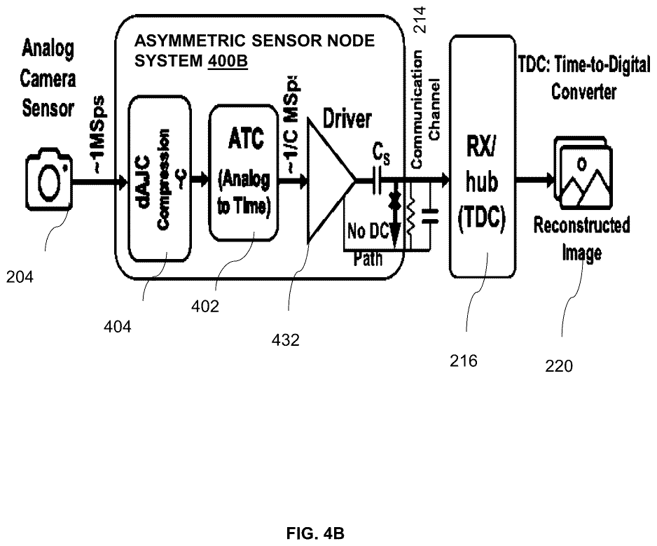

FIGS. 4A-B illustrates exemplary system architecture of asymmetric sensor node system 400A-B, according to an example. Further, the system architecture 400A may be divided into five architectures. In some of the standard architectures, first, system architecture may involve sensing the analog pixel values from the image sensor array via analog camera sensor 204, performing analog to digital conversion, and further communication to the receiver 216 via broadband communication channel 214. In some of the other standard architectures include a, second, system architecture may involve sensing the analog pixel values from the image sensor array, perform analog to digital conversion (ADC), then perform compression of factor (C) on the digitized bits using the Digital Signal Processing (DSP) blocks and then communicate the bits to the receiver 216. Further, in yet some of the other standard architectures include a third, system architecture may involve sensing the analog pixel values from the image sensor array, performing compression (C) in the analog domain using techniques such direct Analog to MJPEG compression (DAJC) techniques, such that only significant samples digitized (reducing ADC energy), further the compressed bits may be communicated to the receiver 216. In contrast, the present network architecture, may include a fourth, system architecture may involve sensing of the analog pixel values from the image sensor array, converting the analog voltage information into analog time information, further performing analog to time conversion (ATC) using ATC converter 402 (also referred herein as linear ATC circuit 212 or ATC system), using pulse width modulation schemes, further communicating the pulse width modulated signal through the communication channel (also referred herein as broadband communication channel 214, or HBC channel) to the receiver 216 as shown in FIG. 4A. The electro quasistatic communication driver unit 432 comprising one of a chain of buffers, adiabatic drivers and at least one inverter. The electro quasistatic communication driver unit 432 is configured to transmit the PWM signal to the receiver 216 over the broadband communication channel 214, and wherein the electro quasistatic communication driver unit 432 is configured to operate in a Return-to-Zero (RZ) mode to transmit the PWM signal, and wherein the PWM signal varies based on analog input waveform representing the analog values. Alternatively, the present network architecture may include a fifth, system architecture may involve sensing of the analog pixels values from the image sensor array 204, performing compression in the analog domain using the compression unit 404, and further convert the compressed analog samples from the analog voltage to time domain converter 402 and further communicate the PWM signal through the broadband communication channel 214 to the receiver 216 as shown in FIG. 4B.

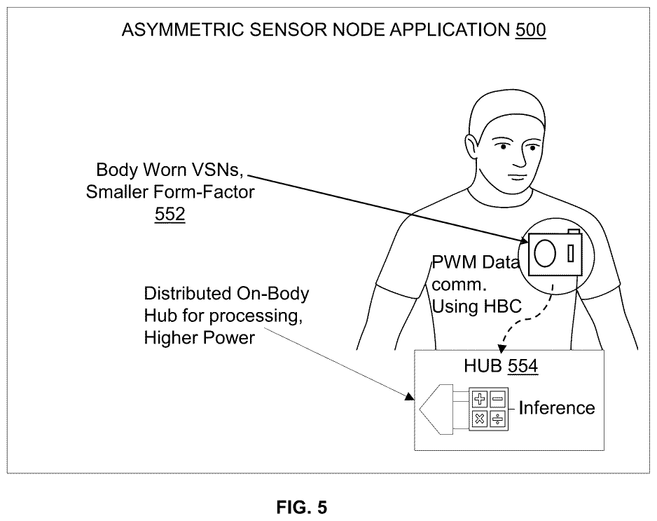

FIG. 5 illustrates an exemplary diagram of small body-worn sensors to collect data and send to a more powerful hub 554 for processing, according to an example embodiment of the present disclosure. As shown, a body-worn analog video sensor node (VSN) 552 may be configured in a compact form factor for inconspicuous or ergonomic integration, may be disposed on a subject and transmits pulse-width modulated (PWM) analog data using Human Body Communication (HBC) to a spatially distributed on-body processing hub 554. Further, the hub 554 having a higher available power budget may be configured to receive the PWM data and perform computationally intensive tasks such as inference and video processing. Furthermore, the body-worn analog video sensor node (VSN) 552 operates under ultra-low-power constraints, optionally powered via energy harvesting, and leverages HBC as a medium for near-field data transmission with minimized energy overhead. The HBC is the broadband communication channel 214.

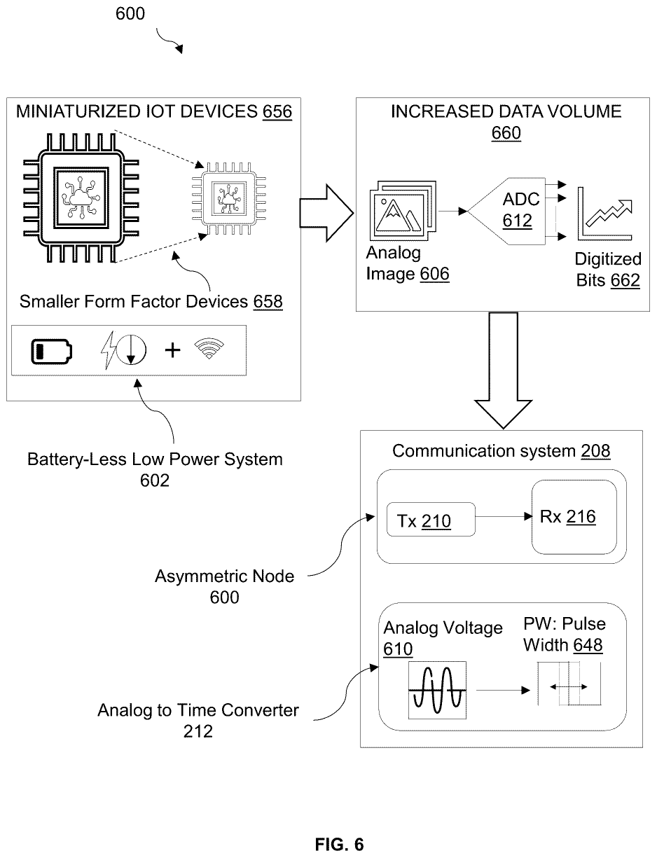

FIG. 6 illustrates an exemplary block diagram of the present system 600 using an analog-to-time converter 216 to perform communication, according to an example. Further, the system 600 may include a miniaturized IoT device module 656, incorporating smaller form factor devices 658 optimized for deployment in battery-less low power systems 602, which further is enabled for low-power communication modalities including wireless transmission, inductive powering, and energy harvesting mechanisms. Furthermore, the FIG. 6 illustrates an increased data volume module 660, comprising an analog image 606 which may be converted to digitized bits 662 using a power-intensive analog-to-digital converter (ADC 612). Further, contributing to elevated data volume and energy requirements incompatible with the low-power constraints of miniaturized and battery-constrained devices. Furthermore, the communication system 208 provides an alternative to conventional digitization by employing an analog-to-time converter 212. An analog voltage 610 may be directly encoded into a corresponding pulse width 648. Furthermore, the encoding may be performed by an asymmetric node 600, including a transmitter (Tx) 210 and the receiver (Rx) 216 facilitating energy-efficient communication by leveraging time-domain signal representation instead of amplitude-domain digital conversion.

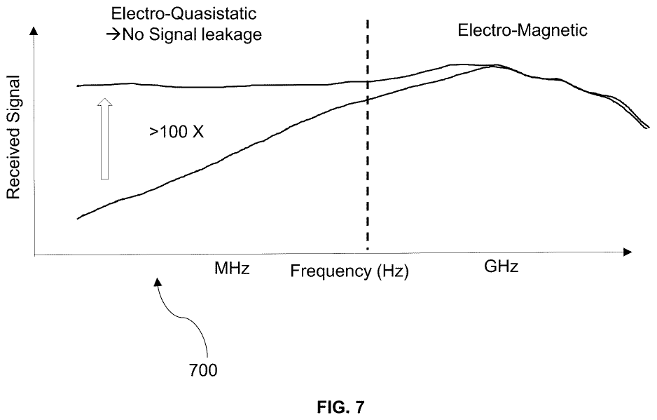

FIG. 7 illustrates an exemplary graphical representation of Electro-Quasistatic (EQS) communication 700 providing over 100× stronger signal with no leakage compared to traditional methods, according to an example. Further, the x-axis represents the transmission frequency ranging from megahertz (MHz) to gigahertz (GHz), and the y-axis represents the received signal strength. Furthermore. a significant divergence in performance is observed between EQS and EM regimes, with a vertical indicator showing an enhancement of greater than 100× in received signal strength in the EQS domain relative to conventional EM communication systems. Furthermore, the left-hand portion of the graph, corresponding to lower frequencies in the MHz range, may be annotated as the Electro-Quasistatic region. In this region, signal propagation is characterized by minimal to no radiative leakage, enabling highly confined and secure communication channels, particularly suitable for body-area networks and near-field intra-body communications. As frequency increases and transitions beyond a threshold (represented by a dashed line), the system enters the Electro-Magnetic domain in the GHz range. In this regime, signal leakage becomes more prominent due to radiative losses, and the received signal strength is comparatively diminished.

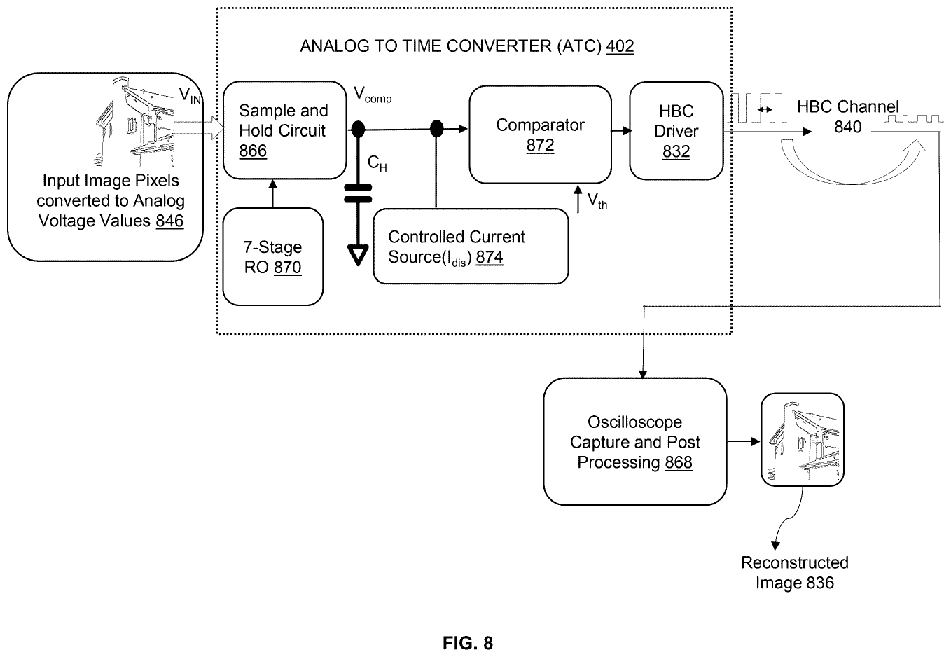

FIG. 8 illustrates an exemplary block diagram of the architecture of an Analog to Time Converter (ATC) system 402 used for image reconstruction, according to an example. Further, an analog input image 846, including image pixel values converted to analog voltages values V_{IN}, may be received and supplied to a sample and hold circuit 866. Further, the sample and hold circuit 866, in conjunction with a 7-Stage Ring Oscillator (RO) 870 stabilizes the incoming analog voltage signal by storing a sampled voltage across a capacitor CH. Furthermore, a controlled current source 874, denoted IpIs discharges the capacitor CH, producing a voltage ramp signal V_{comp}. Furthermore, a Comparator 872 monitors the ramp signal and compares it to a reference level or ground to determine the time at which the ramp crosses a threshold. Further, the time interval corresponds to the analog voltage value and may be used to generate a time-encoded signal representing the original input voltage. Furthermore, the output of the comparator 872 may be transmitted to a Human Body Communication (HBC) Driver 832, which modulates the time-encoded signal onto a HBC channel 840 for transmission. On the receiver side, the signal may be captured via oscilloscope capture and post-processing logic 868, which decodes the time-domain signal to regenerate the original analog voltage values and reconstruct the image output 836.

In accordance with examples of the present disclosure, the pulse width (PW) of the output signal may be mathematically expressed as the given Equation 1 below:

$$\begin{matrix}Pulse \\ Width ( PW )\end{matrix} = CH \frac{d V}{{I}_{dis}} = CH \frac{( Vcomp - Vth )}{{I}_{d i s}} \qquad Equation 1$$

where CH represents the hold capacitance, I_{dis} may denote the controlled discharge current, Vcomp may be the sampled analog voltage, and Vth may be the comparator threshold. Further, the relation facilitates a direct proportionality between the input analog voltage and the timing information encoded in the width of the generated pulse, thereby enabling time-domain encoding of analog voltage signals with ultra-low power consumption.

Further to this, in accordance with an example, the overall ATC system may be implemented in, for example, but not limited to, a 65 nm CMOS process. In an alternate embodiment, this may also be implemented in other technology nodes. To emulate analog image sensing functionality, grayscale pixel values may be read row-wise or column-wise and serially converted into analog voltage levels within a defined dynamic range using an Arbitrary Waveform Generator (AWG). Further, the analog voltage waveforms may be sampled using a high-frequency clock generated on-chip via a 7-stage single-ended Ring Oscillator (RO), designed with current-starved inverters frequency may be tunable via supply voltage or bias currents. A minimum of 4X oversampling may be maintained to ensure faithful post-processing reconstruction. Furthermore, the sampled input may be held on a capacitor of 1 pF, which further may be subsequently discharged through a constant current source that may be controlled using a 5-bit scan interface or a fixed reference current (Iref). At high-speed operation, the discharge current (Idis) enables dynamic control of pulse width for accurately representing the input analog voltages. The voltage across the discharging capacitor may be compared against a programmable reference threshold voltage Vth, generated via a 5-bit DAC, offering further tuning flexibility. Consequently, the generated PWM pulse width is a function of the sampled analog voltage, discharge current, and comparator threshold. Furthermore, the resulting PWM waveform may be transmitted through the HBC driver, which capacitively couples the signal onto the human body. Due to the flat frequency response of the human body in the Electro-Quasi-Static (EQS) regime (up to tens of MHz), the time-domain features-specifically the pulse widths—may be preserved during transmission, with only amplitude attenuation due to channel losses.

Further, the FIG. 8 shows the overall system of the analog time converter based VSN. Furthermore, the analog pixel values in the voltage form are read column-wise which acts as the input to the analog to time converter block. Furthermore, the input waveform may be sampled using a high frequency clock generated using an on-chip clock generation circuit using ring oscillator, LC-based oscillator, crystal oscillator, and the like. At least, a Nyquist rate of oversampling may be maintained for accurate reconstruction of the input in reconstruction at the receiver/hub. A 7-stage single-ended current starved inverters-based RO is used to generate the oversampling clock. Furthermore, the oscillation frequency of the RO may be controlled using the supply voltage or the bias voltage of the current stared device at the pull-up and pull-down of the current starved inverter. Furthermore, the input voltage may be sampled of a capacitor (CH) during the positive phase of the oversampling clock, and then the sampled voltage may be discharged using a constant current source (which may be either controlled by a 5-bit scan control or by changing the reference current), during this phase the discharging sampled voltage is compared against a fixed threshold voltage (Vth), hence generating a pulse width proportional to the time taken to discharge the sampled voltage to the threshold voltage using the constant current source. Such, that a specific pulse width corresponds to a specific pixel voltage value. Furthermore, the generated pulse width modulated (PWM) waveform is then transmitted through the HBC channel 840 using the HBC driver 832 which buffers the signal which gets attenuated through the channel and reaches the receiver or the hub.

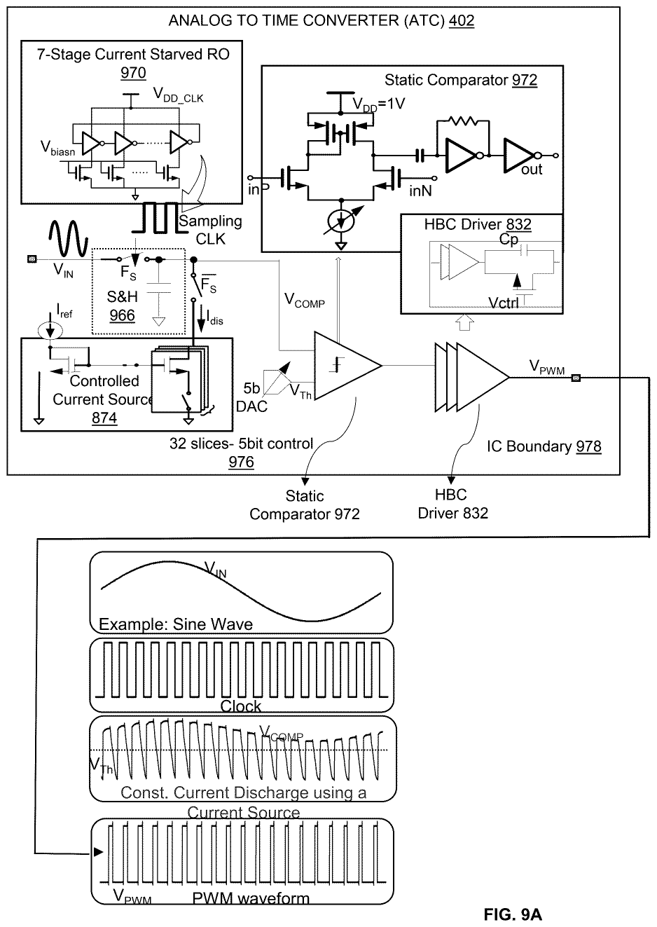

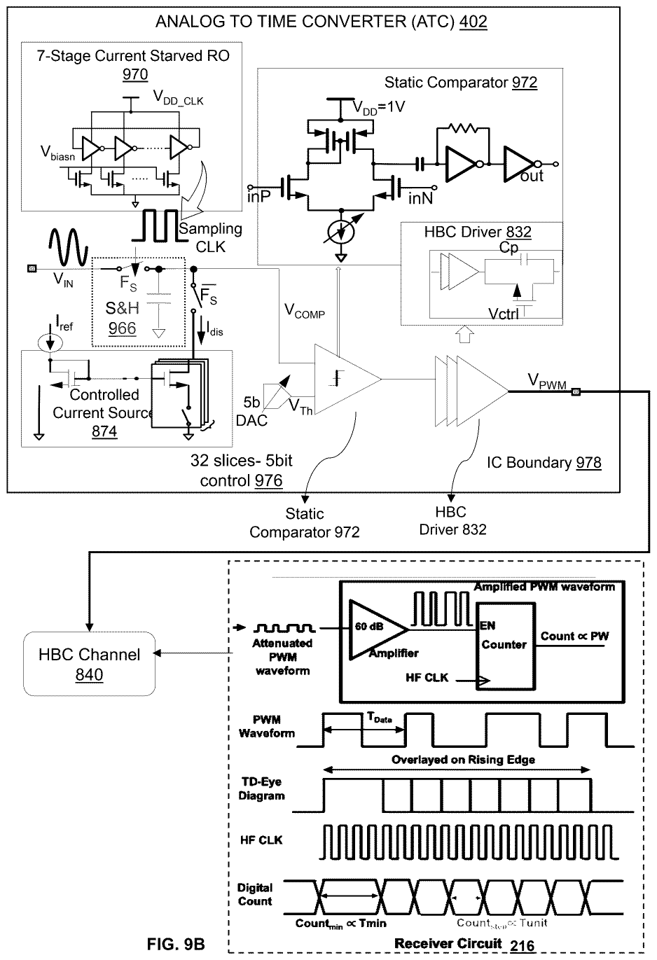

FIGS. 9A-B illustrates a detailed schematic diagram of an Analog-to-Time Converter (ATC) 402 for generating a pulse-width modulated (PWM) waveform corresponding to an analog input signal, according to an example. Further, the FIG. 9A includes a 7-Stage Current Starved Ring Oscillator (RO) 970, configured to generate a clock signal V_{DD,CLK} used for timing and sampling operations. A Sample and Hold (S&H) circuit 966 samples an analog input voltage V_{IN} at a defined sampling frequency Fₛ, storing the voltage across a sampling capacitor CH. A Controlled Current Source 874, programmable via digital control signals, linearly discharges the held voltage V_{H} from the capacitor CH, producing a ramp signal V_{COMP}. This ramp signal may be compared with a reference threshold voltage VREF using a Static Comparator 972, which may be supplied with a bias voltage V_{DD}=IV The comparator output toggles when V_{COMP} intersects the reference, producing a time-domain output signal. Furthermore, the FIG. 9A incorporates a 5-bit Digital-to-Analog Converter (DAC) 976 and a 32-slice control unit for fine-tuning the comparator threshold and ramping characteristics, further enabling accurate analog-to-time conversion for varying input voltage levels. Furthermore, the granularity supports high-resolution conversion by modulating the discharge timing. The comparator output may be fed into an HBC Driver 832 (also referred herein as electro quasistatic driver unit), configured to drive the time-encoded PWM waveform V_{PWM} across an Integrated Circuit (IC) Boundary 978 and onto a Capacitive Human Body Communication (CpHBC) Channel using a voltage swing V_{ctrl}. Furthermore, the HBC driver ensures efficient signal injection into the human body channel with minimal power consumption. At the bottom of the figure, illustrative waveforms may be provided for explanation. Further, a sample analog input V_{IN} may be shown as a sine wave. Furthermore, a high-frequency clock signal may be shown that governs sampling. Furthermore, the linear ramp V_{COMP} due to constant current discharge may be depicted. Furthermore, the resulting PWM waveform V_{PWM}, width may be proportional to the amplitude of V_{IN}, may be shown as the final output.

In an example, the FIG. 9B shows the receiver architecture which receives the attenuated PWM waveform and reconstruct back the transmitted video. At the receiver side a gain is provided to the attenuated waveform proportional to the channel loss. At the receiver, a counter is used working a high frequency (at least 2× of LSB of the pulse width of the transmitter signal). Further, the amplified PWM waveform then acts as the enable signal to the counter. Such that the counter counts during the pulse width, hence with every LSB increase there is an 2× increase in the count (the difference in the count LSB may be increased by increasing the high frequency counter clock). Hence, a time to digital conversion may be achieved, the quantization block input.

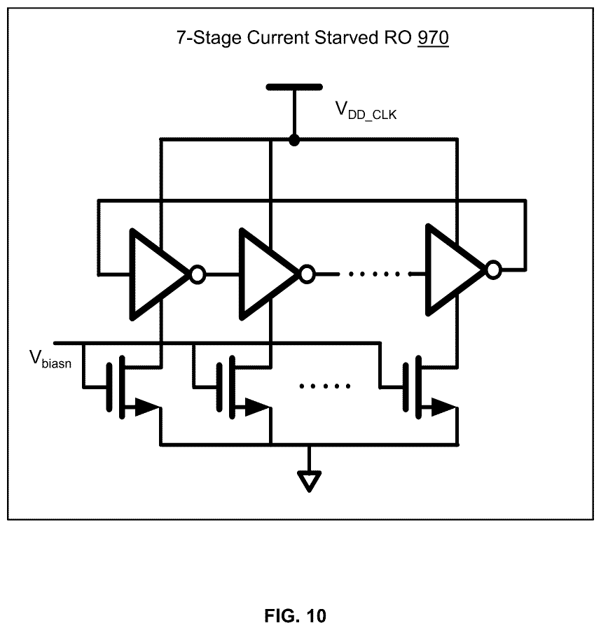

FIG. 10 illustrates an exemplary circuit diagram of a 7-stage current-starved ring oscillator 970, according to an example. Further, the seven inverter stages may be connected in a closed-loop configuration to sustain oscillation, and each inverter may be biased by a pair of current-starving transistors regulated through a bias voltage Vbiasn, further controlling the current flow and modulating the delay across stages to adjust the oscillation frequency; the current-starved architecture enables low-power, compact clock generation suitable for integration within an Analog-to-Time Converter (ATC) framework, particularly for ultra-low-power signal processing in body-area networks and sub-threshold analog systems.

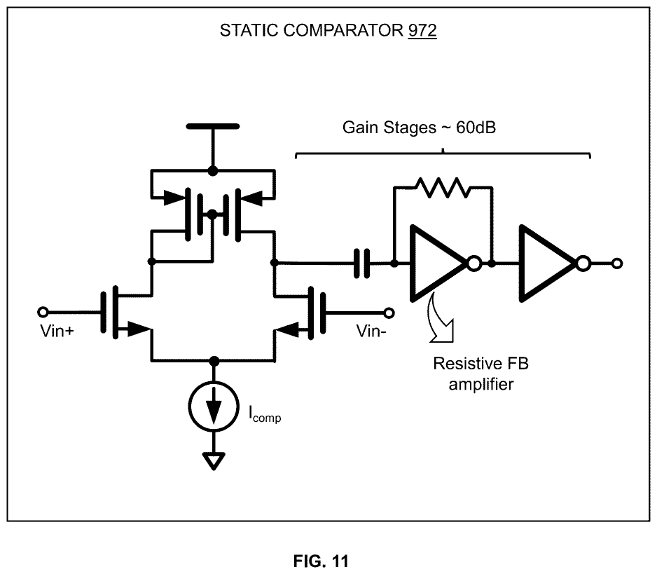

FIG. 11 illustrates an exemplary circuit diagram of a static comparator 972 comparing two input voltages, according to an example. Further, the static comparator circuit 972 includes a differential input stage receiving an input voltage pair Vin+ and Vin−. Further the differential pair may be coupled to a tail current source Icomp and biased by a constant current to enable differential comparison. The static comparator 972 further includes a multi-stage gain amplifier comprising approximately three cascaded gain stages collectively providing a voltage gain of approximately 60 dB, further a resistive feedback network may be configured to stabilize the amplification and improve linearity; the static comparator 972 remains active for approximately half of the signal cycle and generates an output logic level corresponding to the analog input, further determining the rising and falling edges of a pulse and enabling translation of analog input voltage magnitude to a corresponding analog pulse width in the time domain for subsequent processing in time-domain analog-to-time converter (ATC) architectures.

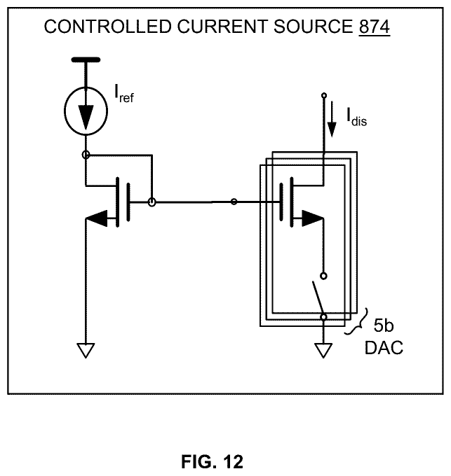

FIG. 12 illustrates an exemplary schematic of a controlled current source 874 that uses a reference current (I_{ref}) and a 5-bit DAC, according to an example. Further, the figure illustrates controlled current source 874 configured to generate a programmable discharge current I_{dis} in response to a reference current I_{ref} and a digital control input from a digital-to-analog converter (DAC), further the DAC may include a 5-bit resolution providing 32 distinct control levels. Further, the figure may include a current mirror configuration for replicating the reference current, and a bank of parallel transistor branches, selectively enabled by the DAC, for modulating the effective current output. Furthermore, the controlled current source 874 may be operable to adjust the discharge current magnitude in accordance with the desired operating frequency of the analog-to-time conversion system, further maintaining consistent performance across varying sampling frequencies and enabling precise tuning of pulse widths in a time-domain encoding architecture.

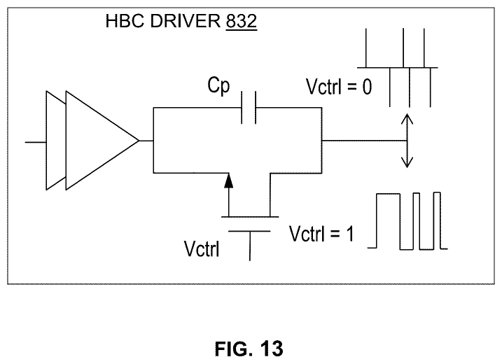

FIG. 13 illustrates an exemplary diagram of HBC Driver circuit 832 (also referred herein as Driver 432) that uses a capacitor (Cₚ) and a control voltage (V_{ctrl}), according to an example. Further, the figure illustrates a Human Body Communication (HBC) driver 832 circuit configured to deliver amplified signal outputs to a human body load impedance. The HBC driver 832 comprises an amplifier stage coupled to a capacitive load Cₚ, and includes a control node V_{ctrl} operable to switch between signaling modes. When V_{ctrl}-0V, the driver generates digital-like signaling with sharp transitions, while when V_{ctrl}=1V, the driver supports non-return-to-zero (NRZ) signaling characteristics. Further, the circuit may be operable to provide sufficient drive strength and signal integrity for capacitive coupling into the human body communication channel 840, and further supports dynamic configurability of the output signaling format based on the logic level applied to V_{ctrl}.

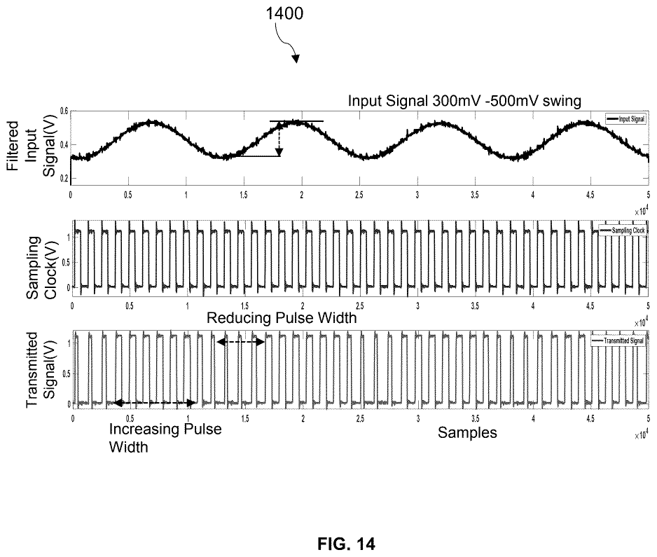

FIG. 14 illustrates an exemplary waveforms 1400 of varying input signal in response to the sampling clock, according to an example. Further, the figure illustrates measurement results corresponding to the pulse-width modulated (PWM) waveform generation based on an analog input signal. The top trace shows a filtered analog input signal exhibiting a peak-to-peak swing in the range of approximately 300 mV to 500 mV. The middle trace depicts a periodic sampling clock used to initiate the sampling process at regular intervals. The bottom trace demonstrates the corresponding transmitted PWM signal, further the pulse width varies in direct correspondence with the instantaneous amplitude of the input signal. Specifically, increasing analog voltage magnitudes result in a proportionally increased pulse width, whereas decreasing analog voltage magnitudes yield a reduced pulse width, this further enables an analog-to-time conversion scheme by modulating the width of digital pulses in response to the amplitude of the analog input signal, facilitating low-power and compact encoding of analog information.

In an example, the graph represents the timing waveforms for an input sinusoid at 5MSps, depicting the variations in the pulse-widths for different voltage levels. The IC generates pulse-width modulated waveform corresponding to the analog voltage values (fed using AWG), which may be coupled to the human body for communication using HBC driver. Further, the PWM signal may be captured using an oscilloscope and further processed in MATLAB. Furthermore, the pulse-widths of received PWM signal may be measured and re-scaled back to voltage levels of the input. For performance evaluation, a standard image processing metrics, the Peak-Signal-to-Noise-Ratio (PSNR) and Structural Similarity Index (SSIM) is used. Different sets of images may be used for validating the functionality of the system.

In another example, the graph represents the continuous time timing waveforms of the input analog voltage waveform, the oversampling clock and the pulse width modulated waveform, illustrating the linear analog voltage to time conversion (ATC). Hence the overall architecture generates pulse-width modulated waveform corresponding to the input analog voltage values. For characterizing the ATC-VSN, pulse widths may be measured corresponding to the analog input voltage for various oversampling clock.

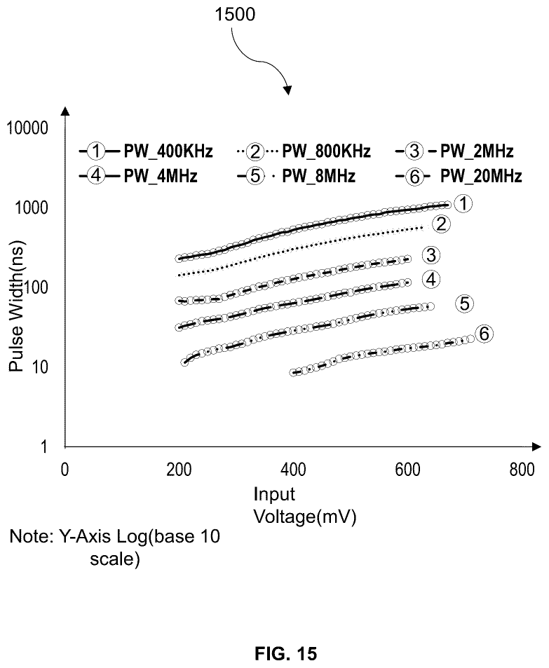

FIG. 15 illustrates an exemplary graphical representation 1500 of relationship between pulse width and input voltage across various sampling rates, according to an example. Further, the horizontal axis represents the input voltage in millivolts (mV), ranging from approximately 100 mV to 800 mV, while the vertical axis represents the corresponding pulse width in nanoseconds (ns), plotted on a logarithmic scale (base 10). The graph includes a plurality of curves, each corresponding to a different sampling frequency, including but not limited to 400 kHz, 800 kHz, 2 MHz, 4 MHZ, 8 MHz, and 20 MHz. Each curve demonstrates a monotonic increase in pulse width with respect to increasing input voltage, thereby evidencing a consistent mapping of analog input voltage to digital pulse width across sampling frequencies. Furthermore, the graph establishes the voltage-to-time domain transduction property of the system, facilitating the encoding of analog voltage signal magnitude into temporally modulated pulse durations for low-power communication and processing applications.

In according to an example, the graph shows the dependency of generated PWM signal for various input data rates, illustrating the dynamic operating range of the input and output signals.

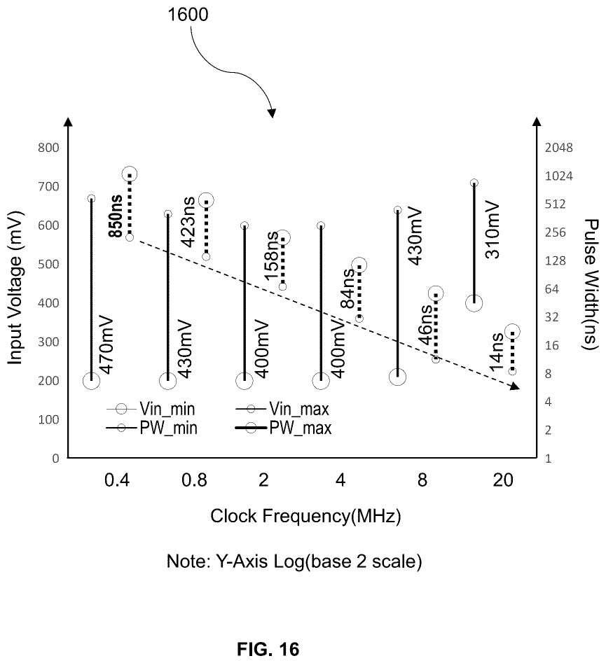

FIG. 16 illustrates an exemplary graphical representation 1600 of input voltage and pulse width range vary with clock frequency, according to an example. Further, the graph illustrates the operating range of the analog-to-time converter (ATC)-based communication system across various sampling frequencies, showing the relationship between input voltage levels and corresponding pulse widths. As the sampling clock frequency increases from 0.4 MHz to 20 MHZ, the effective range of pulse widths decreases, as indicated by the downward-sloping blue dashed line, demonstrating a reduction in timing resolution at higher frequencies. The input voltage range, denoted by Vin_min and Vin_max, also narrows with increasing frequency but may be adaptively maintained by scaling the discharge current in the ATC's controlled current source. Furthermore, the graph validates by dynamically adjusting Idis, the communication system 208 maintain usable pulse width and voltage ranges across a wide spectrum of operating frequencies.

In an example, the graph shows that high frequency operation reduces the dynamic range of pulse-widths as well as it reduces the operable input voltage range. However, by proper calibration of the discharge current Idis and the comparator threshold Vth, the input range may be further extended for operating effectively at higher frequencies.

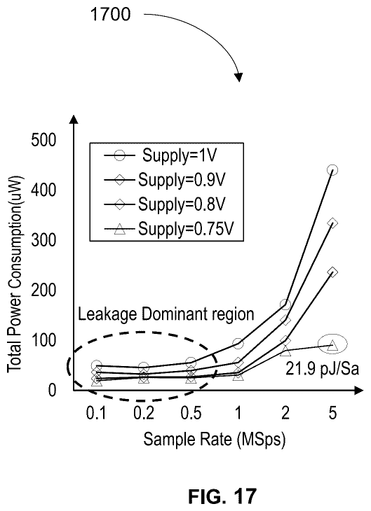

FIG. 17 illustrates graphical representation 1700 of power consumption versus data rate for various supply voltages, according to an example. Further, the graph illustrates the variation of total power consumption with respect to data rate (sample rate) for the analog-to-time converter (ATC)-based communication system under different supply voltages (1 V, 0.9 V, 0.8 V, and 0.75 V). The graph demonstrates that at lower sampling rates (≤0.5 MSps), the system operates in a leakage-dominant region where static power consumption is the primary contributor, as indicated by the flat power trend across voltages. As the data rate increases beyond this region, dynamic power becomes dominant, leading to a sharp rise in power consumption, especially at higher supply voltages. The communication system 208 achieves a minimum energy consumption point of 21.9 pJ/sample, highlighting its energy efficiency at optimal operating conditions.

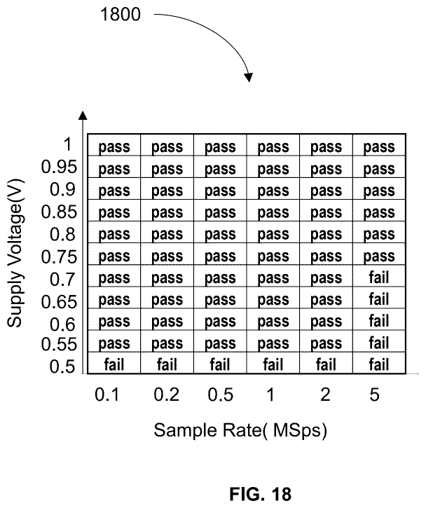

FIG. 18 illustrates an exemplary shmoo plot 1800 of operability of ATC-VSN across supply voltages and sample rates, according to an example. Further, shmoo plot 1800 illustrates the operability of the analog-to-time converter-based voltage sensing node (ATC-VSN) across a range of supply voltages and sample rates. Furthermore, the shmoo plot 1800 confirms successful operation (“pass”) of the system 208 over a wide operating envelope, spanning supply voltages from 0.6 V to 1 V and sample rates from 0.1 MSps to 2 MSps. Failure regions may be observed primarily at lower supply voltages (0.5 V) and higher sample rates (>2 MSps), indicating the system's lower voltage limit for reliable performance.

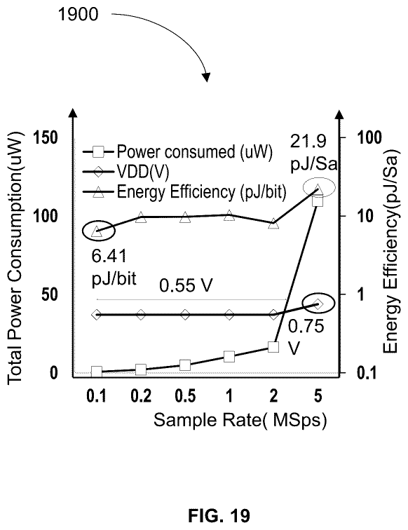

FIG. 19 illustrates an exemplary graphical representation 1900 of energy efficiency versus total power consumption, according to an example. Further, the graph illustrates the relationship between sample rate and energy efficiency, supply voltage (V_{DD}), and total power consumption for the analog-to-time converter (ATC)-based sensor node, demonstrating the trade-offs between performance and power. The first curve shows total power consumption (in uW), which remains relatively flat at lower sample rates and begins to rise significantly at higher data rates, particularly beyond 2 MSps. The second curve represents the operating supply voltage, maintained at a minimum optimal value of 0.55 V up to 2 MSps, and increasing to 0.75 V to sustain higher rates. The third curve depicts energy efficiency (in pJ/sample), which remains within a highly efficient regime, reaching a minimum of 6.41 pJ/bit and 21.9 pJ/sample, validating the ATC's capability for energy-optimal operation.

In an example, the graph shows the power consumption for different input data rates at varying supplies. The IC consumes 0.64 μW-110 μW for sample rate varying from 0.1-5 MSps, which is >100× lower than other reported works in the literature.

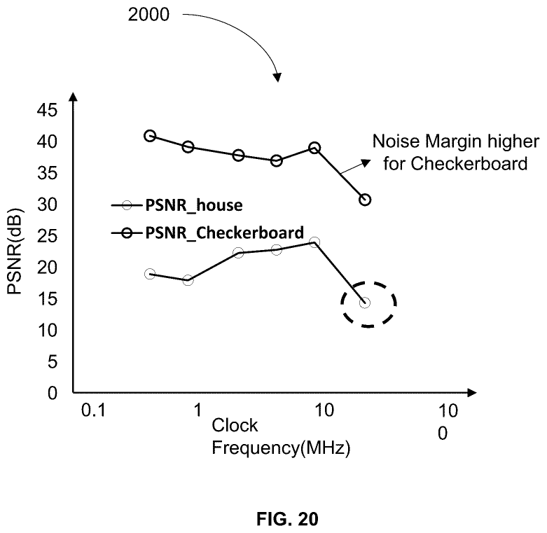

FIG. 20 illustrates an exemplary graphical representation 2000 of the PSNR versus clock Frequency, according to an example. Further, the graph depicts the Peak Signal-to-Noise Ratio (PSNR) performance evaluation of the present analog-to-time converter (ATC)-based communication system 208 for two different image types-natural (house) and synthetic (checkerboard)—across various clock frequencies. PSNR, computed as a pixel-by-pixel quantitative metric, demonstrates superior fidelity for the checkerboard input, with values consistently exceeding 30 dB at lower frequencies and gradually declining as frequency increases. Further, the PSNR values for the natural image remain lower due to inherent complexity and edge variations. Despite this degradation at higher clock rates, the communication system 208 maintains an acceptable reconstruction quality, validating its capability for image-data transmission over human body communication (HBC) channels with minimized loss in high-speed operations.

In an example, the graph presents the shmoo plot which depicts the operability of the IC for various supplies and data rates.

In accordance with examples of the present disclosure, the Peak Signal-to-Noise Ratio (PSNR) may be computed using the following Equation 2:

$$PSNR = 10 \cdot {log}_{10} ( \frac{{R}^{2}}{MSE} ) \qquad Equation 2$$

where R denotes the maximum possible fluctuation in the input image intensity, and MSE represents the mean squared error computed as the cumulative squared deviation between the input and reconstructed image pixels. Further, the given metric may enable quantitative assessment of image reconstruction fidelity, with higher PSNR values indicative of lower distortion and higher reconstruction quality.

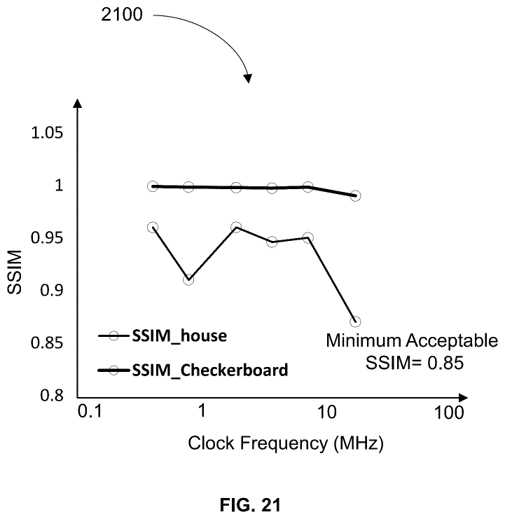

FIG. 21 illustrates an exemplary graphical representation 2100 of the SSIM versus clock Frequency, according to an example. Further, the graph depicts the Structural Similarity Index Measure (SSIM) corresponding to the same image types and frequency sweep, providing a perceptual quality metric of the transmitted image. SSIM values remain consistently above the acceptable threshold of 0.85 for both image categories, even at higher clock frequencies, confirming the preserved structural fidelity of the images through the ATC-based data transmission chain, which further indicates that while pixel-wise accuracy (as reflected in PSNR) may decline with frequency, the perceptual quality of the reconstructed images 220 is reliably sustained, reinforcing the communication system 208 robustness for low-power, high-frequency biomedical and wearable applications requiring high visual integrity.

In an example, the graph shows the optimal V_{DD} to be supplied for efficient functioning of the IC for various data rates. ATC-VSN exhibits a 21.9 pJ/Sample energy efficiency while operating at 5 MSps and 0.75V core V_{DD} supply.

In certain embodiments of the present disclosure, the Structural Similarity Index (SSIM) is computed to evaluate the perceptual similarity between an original and a reconstructed image 220 using the following Equation 3:

$$SSIM = [ \frac{2 {μ}_{1} {μ}_{2}}{{μ}_{1}^{2} + {μ}_{2}^{2}} ] \times [ \frac{2 {σ}_{12}}{{σ}_{1}^{2} + {σ}_{2}^{2}} ] \qquad Equation 3$$

where

$${μ}_{1}^{2} and {μ}_{2}^{2}$$

represent the mean pixel intensities of the original and reconstructed images, respectively;

$${σ}_{1}^{2} and {μ}_{2}^{2}$$

denote the corresponding variances; and σ₁₂ denotes the covariance between the two images. The SSIM metric provides a perceptual measure of image quality by accounting for luminance, contrast, and structural information, with values closer to 1 indicating higher structural similarity and better visual fidelity.

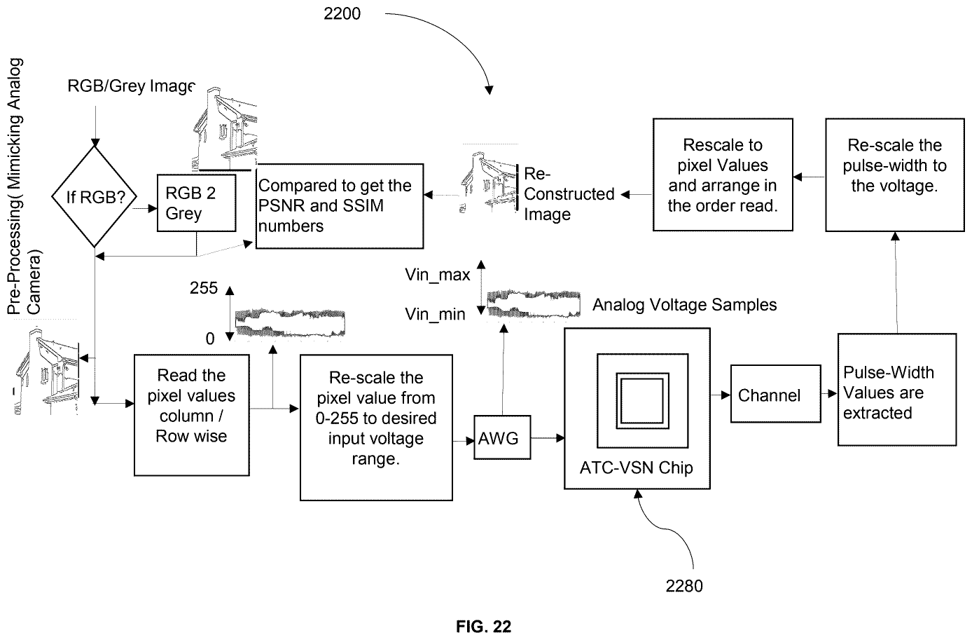

FIG. 22 illustrates an exemplary block diagram representation 2200 of end-to-end flow of image processing using the ATC-VSN chip, according to an example. Further, the block diagram illustrates the end-to-end image transmission and reconstruction flow of the present Analog-to-Time Converter-based Visual Sensor Node (ATC-VSN) system 208 tailored for ultra-low-power human body communication (HBC) applications. Furthermore, the process begins with preprocessing an input image either RGB or grayscale to mimic analog camera behavior. RGB images are converted to grayscale and pixel intensities (0-255) are read sequentially in a row/column-wise fashion. Furthermore, the digital intensity values may be linearly rescaled to a predefined analog voltage range Vin_min to Vin_max suitable for the ATC. The resulting analog voltage samples are generated via an Arbitrary Waveform Generator (AWG) and supplied to the ATC-VSN chip, where voltage-to-time domain conversion may be performed. Furthermore, the modulated pulse-widths may be transmitted across a broadband communication channel 214. On the receiver side, pulse-widths may be extracted and rescaled back to voltage values, then mapped back to the corresponding pixel intensity levels and reassembled to reconstruct the original image. Furthermore, the reconstructed image 836 (similar to reconstructed image 220 shown in FIG. 2), may be quantitatively evaluated using PSNR and SSIM metrics against the original input, further validating the system's ability to faithfully preserve image integrity in ultra-low-power, analog-domain processing scenarios.

In an example, the diagram illustrates evaluating the performance of the IC 2280 for different sets of images using PSNR and SSIM metrics. Checkerboard images exhibit better reconstruction qualities due to higher dynamic range at the input. A value >0.85 SSIM, user perception metric, is chosen as the acceptable image quality for the present work, which is considered a standard for several image processing applications.

In accordance with the disclosed examples, Table 1 presented below represents a comparative analysis of existing state-of-the-art systems for sensing and communication applications. The table highlights key performance parameters, including sensing implementation style, communication mode, data rate, power consumption, energy efficiency, dynamic range, area, and technology node

TABLE 1

| | Present | | | | | |
|---|---|---|---|---|---|---|
| | Work | Prior Art 1 | Prior Art 2 | Prior Art 3 | Prior Art 4 | Prior Art 5 |
| Target | ATC + | Video | Sensing | Communi- | Communi- | Communi- |
| Application | Communi- | Sensing + | Only | cation | cation | cation |
| | cation | Communi- | | | | |
| | | cation | | | | |
| Sensing | Yes | Yes | Yes | | | |
| Implemen- | Analog to | Analog to | Analog to | Coherent | OOK | BPSK |
| tation Style/ | Time | Time | Time | BPSK | | |
| Communi- | Conversion | Conversion | Conversion | | | |
| cation Mode | | | | | | |
| Sample/Data | 100K-5 | 1 | | 80 | 100 | 80 |
| Rate | MSps | MSps | | Mbps | Kbps | Mbps |
| IC Solution | Yes | No | Yes | Yes | Yes | Yes |
| Power Supply | 0.75-1 | 3.7 | 0.5 | 1.2 | 0.8 | 1.1 |
| Communi- | HBC | Backscatter | | BCC | BCC | BCC |
| cation | | | | | | |
| Medium | | | | | | |
| Power | 109.5 uW | 15.66 mW | | 6.32 mW | 43 mW | 1.76 mW |
| Consumption | (5 MSps) | (1 MSps) | | (80 Mbps) | (100 Kbps) | (80 Mbps) |
| Energy | 21.9 | 15.66 | 140 nJ/ | 79 | 430 | 22 |
| Efficiency | pJ/Sa | nJ/Sa | frame or | pJ/bit | nJ/bit | pJ/bit |
| | | | 8 pJ/Sa | | | |
| Dynamic | 300-470 | 100 | | | | |
| Range | mV | mV | | | | |
| Area | 0.375 × 0.1 | 3.5 × 3.5 × | 1.28 × 0.85 | 1.8 × 3.2 | 1.8 × 3.2 | 2 × 4 |
| | mm² | 3.5 cm³ | mm² | mm² | mm² | mm²(Only |
| | | | | | | TX) |
| Technology | 65 nm | COTS | 130 μm | 65 nm | 65 nm | 65 nm |
| | CMOS | Components | CMOS | CMOS | CMOS | CMOS |

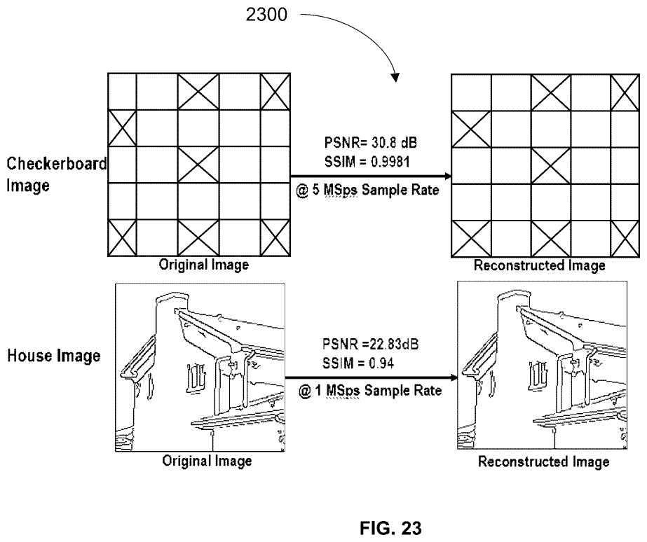

FIG. 23 illustrates visual comparisons 2300 between original and reconstructed images for evaluating the image fidelity of the present analog-to-time converter (ATC)-based communication system 208, according to an example. The top row shows a checkerboard test image, transmitted and reconstructed at a sample rate of 5 MSps, achieving a Peak Signal-to-Noise Ratio (PSNR) of 30.8 dB and Structural Similarity Index (SSIM) of 0.9981, indicating near-lossless reconstruction with high structural accuracy. The bottom row depicts a natural house image, processed at a lower sample rate of 1 MSps, yielding a PSNR of 22.83 dB and SSIM of 0.94, demonstrating acceptable visual quality and preservation of perceptual features.

In according to an example figure (top) shows the input and reconstructed images and test-chip specifications. Reconstructed test images exhibits >22 dB PSNR and >0.93 SSIM values. Further, the figure (bottom) shows the off-chip offline pre and post processing done in MATLAB, demonstrating the entire test flow

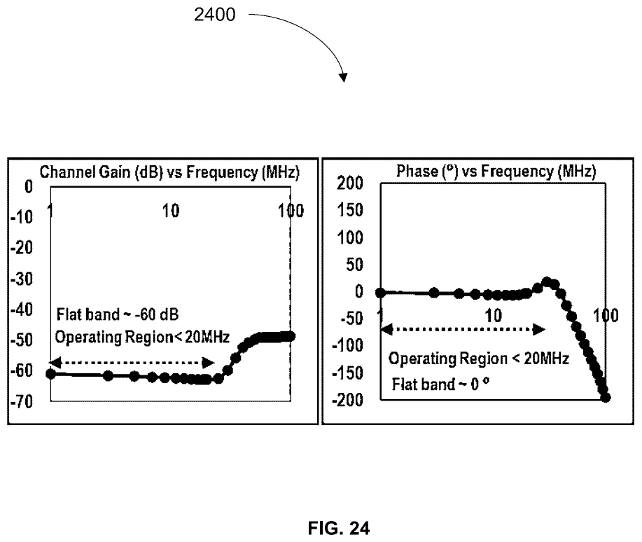

FIG. 24 illustrates a graph 2400 depicting broadband communication channel required to lower the communication energy efficiency, according to an example. The communication channel shown may be for a voltage mode communication in the Electro-Quasistatic Human Body Communication (EQS-HBC). Further, the figured illustrates that DC to 20 MHz frequency the channel may be broadband and include a channel loss equivalent to ~60 dB. Furthermore, the phase remains the constant at 0 degree, which conserves the time domain information in the transmitted signal.

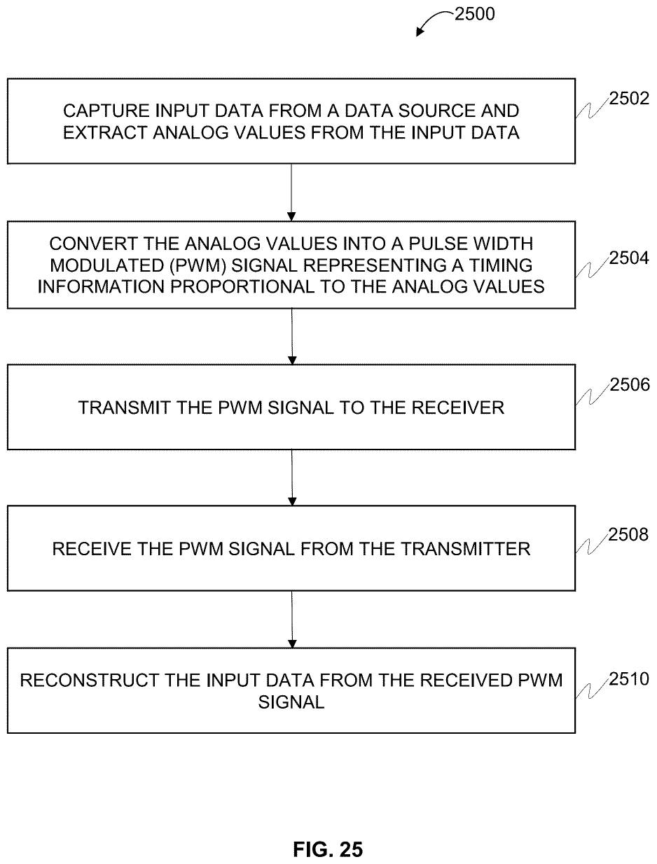

FIG. 25 illustrates an exemplary flowchart 2500 for optimizing power using analog voltage-to-time converter-based sensor nodes, by communication system 208, according to an example.

At step 2502, the method 2500 includes capturing, by the processor 302, input data from a data source and extract analog values from the input data. Further, the data source may be referred to an analog camera sensor 204.

At step 2504, the method 2500 includes converting, by the processor 302, the analog values into a pulse width modulated (PWM) signal representing a timing information proportional to the analog values. Further, the conversion may be achieved using a linear analog-to-time converter (ATC) circuit 212 configured to generate a ramp signal that intersects a comparator threshold to determine a time-domain encoding of the analog input.

At step 2506, the method 2500 includes transmitting, by the processor 302, the PWM signal to the receiver 216. Further, the transmission may be carried out over a broadband communication channel 214 interface to ensure minimal power loss and secure delivery of the encoded signal.

At step 2508, the method 2500 includes receiving, by the processor 302, the PWM signal from the transmitter 210. Further, the receiver 216 may include a time-to-digital converter (TDC) circuit configured to detect the pulse width variations and recover timing information encoded within the transmitted PWM signal.

At step 2510, the method 2500 includes reconstructing, by the processor 302, the input data from the received PWM signal. Further, the reconstruction may involve measuring the pulse width of the received signal and mapping it back to a corresponding analog value or digital representation of the original input data.

The method 2500 may be implemented in any suitable hardware, software, firmware, or combination thereof. The order in which the method 2500 is described is not intended to be construed as a limitation, and any number of the described method blocks may be combined or otherwise performed in any order to implement the method 2500 or an alternate method. Additionally, individual blocks may be deleted from the method 2500 without departing from the spirit and scope of the present disclosure described herein. Furthermore, the method 2500 may be implemented in any suitable hardware, software, firmware, or a combination thereof, that exists in the related art or that is later developed. The method 2500 describes, without limitation, the implementation of the communication system 208. A person of skill in the art will understand that method 2500 may be modified appropriately for implementation in various manners without departing from the scope and spirit of the disclosure.

Various examples of the present disclosure provide systems and methods for optimizing power using analog voltage-to-time converter-based sensor nodes. The disclosed framework utilizes constant current discharge, sample-and-hold circuitry, and static comparators to convert analog input signals into time-domain pulse width modulated (PWM) representations, which are subsequently transmitted via energy-efficient channels such as Human Body Communication (HBC). By eliminating the need for high-speed analog-to-digital converters (ADCs) and digital signal processing (DSP) blocks, the architecture significantly reduces power consumption while preserving signal fidelity. Additionally, the time-domain encoding inherently enhances resistance to noise and signal leakage, ensuring secure and robust data transmission across bandwidth-limited or power-constrained environments. This advancement is particularly advantageous for wearable biomedical devices, brain implants, and secure body-area networks, where power efficiency and data integrity are critical for continuous, real-time operation.

An ultra-low-power video sensor node is disclosed that is friendly to small battery or energy harvesting-based systems. This system uses the ultra-low-power communication technique and direct analog-to-time conversion of the image pixels. The above mechanism removes the need for any high-power ADCs, lowering the total system power of the sensor node. The advantage of removing the ADC from the system is negated if the communication technique is not energy efficient. Thus, along with the analog voltage to time conversion-based solution, a low-power communication technique is required. The ultra-low power communication may be achieved using a broadband communication channel, which is much lower power compared to traditional wireless communication schemes like Wi-Fi, BLE, Bluetooth, backscatter communication, wireline: The broadband communication channel may be a Voltage mode Electro-Quasistatic Human Body Communication (EQS-HBC) or a Time domain body communication (TD-BC). The broadband channel does not distort the time domain information. A lossy channel will affect the voltage domain information without affecting the time information, thereby allowing the communication system to be simple and hereby achieving better energy efficiency. The overall system involves image sensing pixels followed by a linear analog voltage to time converter circuit, which converts the analog pixel information to timing information, preserving the information in the time domain. The analog to time conversion system is achieved by sampling the sensed analog pixel voltage using the sample and hold circuit on a capacitor using an oversampling clock. The sampling operation happens in the positive phase of the oversampling clock. Then in the negative phase the capacitor is linearly discharged using a constant current source and continuously compared against a fixed threshold voltage using a comparator. When the voltage on the capacitor being discharged crosses the threshold voltage, a time pulse proportional to the sampled voltage is generated.

The oversampling clock in the implementation is generated using a 7-stage ring oscillator. However, it may be generated using an n-stage ring oscillator, crystal oscillator, injected locked oscillator, and phase locked loop along with a reference clock. The constant current source may be a current source, simple current mirror, cascaded current mirroring, self-biased current mirror, or any current mirroring techniques. Although the positive sampling phase duration employed is half a clock cycle of the oversampling clock, it may be reduced depending on the charging time of the sampling capacitor to the input voltage range. This increases the discharge duration of the capacitor and, hence, the overall pulse width for representing the input analog voltage.

In the implementation, the input voltage range is higher (ranging from half supply voltage to supply voltage), so NMOS-based devices are employed. However, if the analog input pixels' voltages are mapped to lower voltages, PMOS-based architectures may be employed. Based on the input voltage range instead of discharging the voltage on the capacitor, it may be charged and compared against a higher threshold voltage, and once the voltage crosses the upper limit, a pulse is generated which is proportional to the charging time. The comparator may be modified to handle the lower input voltage range with PMOS-based devices. With the increase in the frequency of the operation and the input voltage range, the threshold value, the constant current source, and the comparator sensitivity has to be adjusted accordingly.

The overall system using an analog voltage-to-time converter (ATC)-based system may be extended by performing compression in the analog domain, followed by analog voltage-to-time conversion and then communication. Compressing the signal in the analog domain before the ATC helps accommodate traditional communication techniques. That is, if the compression factor is C, then a C times worse energy-efficient communication technology may be employed. Employing compression in the analog domain before ATC allows a higher data rate (C times) and, hence, higher video resolution in conjunction with a low-power communication technology.

In addition to the compression operation on the incoming analog voltage samples, various computations may be performed on them in the analog domain to extract features, perform image classification. The pulse width modulated waveform is sent through the broadband communication channel using a chain of buffers/two inverters, which makes the communication driver to be simple and low power, owing its broadband nature.

In addition to the inverter-based circuit, adiabatic drivers may be used to lower the communication power consumption.

At the receiver, a time to digital converter (TDC) circuit is used to retrieve the transmitter information. It includes a high frequency counter, working with an oversampling high frequency clock. The counter is enabled only during the pulse width of the PWM signal, such that the counter counts when there is a pulse.

The time-to-digital circuit uses a counter working on a high-frequency clock whose frequency is determined by the lowest bit resolution (LSB) in the time domain. The minimum count output is the pulse width corresponding to the minimum input voltage, with every LSB step, the counter output is increased by the oversampling factor of the high frequency counter clock to the lowest time domain step (LSB) in the time domain.

For n bit resolution of a LSB, the high frequency clock frequency needs to be n times faster than the frequency of LSB time step. The time-to-digital converter circuit employed is based on a high-frequency counter; however, delay-line-based TDC or analog TDC may be used to digitize the time information at the receiver. In this implementation, a 480p resolution video at 6 frames per second (fps) is achieved; however, a higher data rate with a larger resolution and higher fps may be handled. Although this technique of analog communication using a PWM signal employing analog-to-time conversion has been used for video communication, it may also be used for communicating audio, medical information, and neural signals.

In an example, the communication system 208 may be connected to any external systems (not shown) for further processing of the reconstructed images. In one example embodiment, the communication system 208 may also include a hardware processor(s) 302 which may be coupled to a memory 304. The memory 304 may include a plurality of modules/subsystems 308. The system 208 may be a hardware device including the hardware processor executing machine-readable program instructions for converting the direct analog samples to compressed digitized samples. Execution of the machine-readable program instructions by the hardware processor 302 may enable the communication system 208 to convert the direct analog samples to compressed digitized samples. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The hardware processor(s) 302 may include, but are not limited to, microprocessors, microcomputers, microcontrollers, digital signal processors, central processing units, state machines, logic circuits, and/or any devices that manipulate data or signals based on operational instructions, and the like. Among other capabilities, hardware processor may fetch and execute computer-readable instructions in the memory 304 operationally coupled with the communication system 208 for performing tasks such as data processing, input/output processing, and/or any other functions. Any reference to a task in the present disclosure may refer to an operation being or that may be performed on data.

One of the ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, a. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A communication system for optimizing power using analog voltage-to-time converter based sensor nodes in a communication environment, wherein the communication system comprises:
a data acquisition unit configured to capture input data from a data source and extract analog values from the input data;
a transmitter communicatively coupled to the data acquisition unit, wherein the transmitter comprises a linear analog voltage-to-time converter (ATC) circuit, wherein the linear ATC circuit is configured to convert the analog values into a pulse width modulated (PWM) signal representing a timing information proportional to the analog values;
a broadband communication channel coupled between the transmitter and a receiver, wherein the broadband communication channel is configured to transmit the PWM signal to the receiver; and
the receiver communicatively coupled to the transmitter via the broadband communication channel, wherein the receiver comprises a time-to-digital converter (TDC) circuit configured to receive the PWM signal from the transmitter via the broadband communication channel and reconstruct the input data from the received PWM signal.

2. The communication system of claim 1, wherein the linear ATC circuit comprises:
a multi-stage oscillator configured to generate a sampling clock for a sample-and-hold circuit based on the analog values;
the sample-and-hold circuit communicatively coupled to the multi-stage oscillator, wherein the sample-and-hold circuit is configured to sample the analog values using the sampling clock and hold a sampled voltage on a capacitor, wherein the sampling comprises a positive sampling phase duration depends on charging time of the capacitor to an input voltage range;
a controlled current source configured to discharge the sampled voltage on the capacitor based on the positive sampling phase duration; and
a comparator configured to compare the discharging voltage with a threshold voltage and generate the pulse width modulated (PWM) signal, wherein the PWM signal comprises a pulse width being proportional to the analog values; and
wherein the linear ATC circuit comprises at least one of a combination of NMOS-based device and a PMOS-based device if the analog input voltage is from a lower voltages to a supply voltage, and wherein the linear ATC circuit comprises at least one PMOS-based device if the analog values are mapped to lower voltages.

3. The communication system of claim 2, wherein the multi-stage oscillator corresponds to one of an n-stage ring oscillator, crystal oscillator, injected locked oscillator, and phase locked loop along with a reference clock, and wherein the sampling clock comprises a frequency adjustable between 10 kHz and 25 MHz by controlling using a controlling knob, wherein the controlling knob comprises a bias voltage (Vbiasn) and a supply voltage (V_{DD}_CLK) of the multi-stage oscillator.

4. The communication system of claim 2, wherein the controlled current source is configured to:
adjust a discharge current based on an operating frequency of the transmitter, wherein the discharge current increases with higher input frequencies and decreases with lower input frequencies; and
adjust a threshold value, and a sensitivity level of each of the controlled current source and the comparator based on the operating frequency and an input voltage range.

5. The communication system of claim 4, wherein the controlled current source is configured to:
perform a coarse tuning of the discharge current by varying a reference current to a specific current value; and
perform a fine tuning of the discharge current by using a n-bit digital-to-analog converter (DAC).

6. The communication system of claim 2, wherein the comparator comprises a current mirror load amplifier followed by resistive feedback amplifiers generating a gain of 60 dB, and wherein the comparator is configured to operate during a discharge phase of the sampled voltage.

7. The communication system of claim 1, wherein the transmitter further comprises:
an electro quasistatic communication driver unit comprising one of a chain of buffers, adiabatic drivers and at least one inverter, wherein the electro quasistatic communication driver unit is configured to transmit the PWM signal to the receiver over the broadband communication channel, and wherein the electro quasistatic communication driver unit is configured to operate in a Return-to-Zero (RZ) mode to transmit the PWM signal, and wherein the PWM signal varies based on analog input waveform representing the analog values.

8. The communication system of claim 7, wherein the electro quasistatic communication driver unit is further configured to selectively generate one of a BiPhasic signal and an On-Off Keying (OOK)-like signal based on a control voltage (V_{ctrl}), wherein the BiPhasic signal is generated when the control voltage (V_{ctrl}) is ON, and the OOK-like signal is generated when the control voltage (V_{ctrl}) is OFF.

9. The communication system of claim 2, wherein the sample-and-hold circuit is configured to: sample the analog values during a first phase of the sampling clock, and the controlled current source is configured to discharge the sampled voltage during a second phase of the sampling clock, and wherein the second phase being opposite to the first phase.

10. The communication system of claim 1, wherein the receiver comprises:
a processing unit configured to:
capture the PWM signal transmitted from the transmitter via the broadband communication channel; and
reconstruct the input data from the PWM signal by converting the pulse widths into corresponding values.

11. The communication system of claim 10, wherein the TDC circuit comprises:
a counter operating with an oversampling high-frequency clock, wherein the counter is enabled during a pulse width of the PWM signal, and wherein the counter is configured to count during a presence of a pulse, wherein the oversampling high-frequency clock comprises a frequency determined by a lowest bit resolution (LSB) in time domain; and
the processing unit configured to:
enable the counter during the pulse width of the PWM signal, wherein the counter generates a count output corresponding to a timing information of the PWM signal and wherein the count output corresponds to the pulse width corresponding to a minimum input voltage; and
increment, during each LSB step, the counter output by the oversampling factor of the high frequency counter clock to the lowest time domain step (LSB) in the time domain.

12. The communication system of claim 11, wherein the TDC circuit corresponds to one of a delay-line-based TDC and an analog TDC.

13. The communication system of claim 2, wherein the analog values are derived from an analog input waveform, and wherein the PWM signal generated by the comparator reflects variations in the analog input waveform through corresponding changes in the pulse width.

14. The communication system of claim 1, wherein the broadband communication channel comprises at least one of a voltage mode Electro-Quasistatic Human Body Communication (EQS-HBC) and a Time Domain Body Communication (TD-BC).

15. The communication system of claim 2, wherein the linear ATC circuit further comprises:
an analog compression circuit coupled between the data acquisition unit and the sample-and-hold circuit, wherein the analog compression circuit is configured to compress the analog values by a compression factor (C) in an analog domain before conversion to the PWM signal.

16. A method for optimizing power using analog voltage-to-time converter based sensor nodes in a communication environment, wherein the method comprises:
generating, by the transmitter via a multi-stage oscillator, a sampling clock for a sample-and-hold circuit based on analog values extracted from an input data, wherein the input data is captured from a data acquisition unit;
sampling, by the transmitter via a sample-and-hold circuit, the analog values using the sampling clock and hold a sampled voltage on a capacitor;
discharging, by the transmitter via a controlled current source, the sampled voltage on the capacitor;
comparing, by the transmitter via a comparator, the discharging voltage with a threshold voltage to generate a pulse width modulated (PWM) signal, wherein the PWM signal comprises a pulse width proportional to the analog values; and
transmitting, by the transmitter via an electro quasistatic communication driver unit, the generated PWM signal to a receiver over a broadband communication channel.

17. The method of claim 16, further comprising:
adjusting, by the transmitter via the multi-stage oscillator, a frequency of the sampling clock between 10 kHz and 25 MHz by controlling using a controlling knob, wherein the controlling knob comprises a bias voltage (Vbiasn) and a supply voltage (V_{DD}_CLK) of the multi-stage oscillator.

18. The method of claim 16, further comprising:
adjusting, by the transmitter via the controlled current source, a discharge current based on an operating frequency of the transmitter, wherein the discharge current increases with higher input frequencies and decreases with lower input frequencies; and
adjusting, by the transmitter via the controlled current source, a threshold value, and a sensitivity level of each of the controlled current source and the comparator based on the operating frequency and an input voltage range.

19. The method of claim 16, wherein transmitting the generated PWM signal to the receiver over the broadband communication channel comprises:
operating, by the transmitter, the electro quasistatic communication driver unit in a Return-to-Zero (RZ) mode to transmit the PWM signal, and wherein the PWM signal varies based on an analog input waveform representing the analog values.

20. The method of claim 16, wherein transmitting the generated PWM signal to the receiver over the broadband communication channel comprises:
selectively generating, by the transmitter via the electro quasistatic communication driver unit, at least one of a BiPhasic signal and an On-Off Keying (OOK)-like signal based on a control voltage (V_{ctrl}), wherein the BiPhasic signal is generated when the control voltage (V_{ctrl}) is ON, and the OOK-like signal is generated when the control voltage (V_{ctrl}) is OFF.
